(19) United States
(12) Patent Application Publication
(10) Pub. No.: US 2026/0048978 A1
(43) Pub. Date: Feb. 19, 2026

(54) POSITION BASED SMART ELBOW CROSSOVER PROTECTION SYSTEM

(71) Applicant: Knappco, LLC, Hamilton, OH (US)

(72) Inventors: Mark William Dudley, Kansas City, MO (US); Prajnith Vijaya Kumar, Mangalor (IN); Hee Chun, Lawrence, KS (US)

(73) Assignee: Knappco, LLC, Hamilton, OH (US)

(21) Appl. No.: 19/082,483

(22) Filed: Mar. 18, 2025

(30) Foreign Application Priority Data
Mar. 21, 2024 (IN) 202411021581

(51) Int. Cl. B67D 7/34; B67D 7/04

(52) U.S. Cl. CPC B67D 7/348; B67D 7/04

(57) ABSTRACT

A crossover protection system includes a processor, a memory, and machine readable instructions. The machine readable instructions cause the processor to determine a smart elbow position based on a signal output of a sensor of a smart elbow and determine whether the smart elbow position is within a geofence of a distribution tank including a same fuel type as a liquid product stored in a tank compartment. The processor further, in response to a determination that the smart elbow position is within the geofence of the distribution tank of the same fuel type as the liquid product, permits the liquid product to the distribution tank, and in response to a determination that the smart elbow position is outside the geofence of the distribution tank of the same fuel type as the liquid product, prevents the liquid product from flowing to the distribution tank.

### CROSS-REFERENCE TO RELATED APPLICATIONS

This application claims priority to Indian Patent Application No. 202411021581 filed Mar. 21, 2024, and entitled “POSITION BASED SMART ELBOW CROSSOVER PROTECTION SYSTEM.” The contents of the above noted application is hereby incorporated by reference in its entirety.

### BACKGROUND

### Field

The present specification generally relates to crossover protection systems for liquid product delivery vehicles and, more specifically, to crossover protection systems operable to reduce errors during unloading of liquid product delivery vehicles.

### Technical Background

Distribution of liquid products, such as liquid fuels for vehicles, may generally include unloading one or more liquid products from a product delivery vehicle at a loading location, transporting the liquid products to a fueling station, and unloading the liquid products from the product delivery vehicle into a fuel tank or container at the fueling station. The fueling station often includes multiple fuel tanks containing fuels of various types. Efficient distribution of liquid products may depend on effectively matching the types of fuels within the tank compartments of the product delivery vehicle with the types of fuels in fuel tanks at fueling facilities.

Crossover protection systems may be used to prevent the undesirable crossover, cross contamination, and/or co-mingling that result when a liquid is delivered from a tank compartment of a product delivery vehicle to a fuel tank of a fueling facility that contains a different type of liquid. It may be desirable for a user of such a system to be provided a location-based crossover protection system to prevent undesirable crossover. Accordingly, a need exists for crossover protection systems with location-based confirmation of fuel type to be unloaded at a particular fuel tank at a fueling station.

### SUMMARY

In one embodiment of the present disclosure, a crossover protection system includes a processor of an electronic control unit, a network interface hardware communicatively coupled to the processor, at least one memory module communicatively coupled to the processor, and machine readable instructions stored in the at least one memory module. The machine readable instructions stored in the at least one memory module cause the processor to determine a smart elbow position based on a signal output of a sensor of a smart elbow, wherein the smart elbow is configured to be fluidly coupled to a tank compartment of a product delivery vehicle and determine whether the smart elbow position is within a boundary or geofence of a distribution tank including a same fuel type as a liquid product, wherein the liquid product is stored in the tank compartment of the product delivery vehicle. The machine readable instructions further cause the processor to, in response to a determination that the smart elbow position is within the boundary or geofence of the distribution tank of the same fuel type as the liquid product, permit the liquid product to flow from the tank compartment of the product delivery vehicle to the distribution tank, and in response to a determination that the smart elbow position is outside the boundary or geofence of the distribution tank of the same fuel type as the liquid product, prevent the liquid product from flowing from the tank compartment of the product delivery vehicle to the distribution tank.

In another embodiment of the present disclosure, a crossover protection system includes a product delivery vehicle including a tank compartment for containing a liquid product, an electronic control unit including a processor, a network interface hardware communicatively coupled to the processor, at least one memory module communicatively coupled to the processor, and machine readable instructions stored in the at least one memory module. The crossover protection system also includes a smart elbow fluidly coupled to the tank compartment and the communicatively coupled to the electronic control unit. The machine readable instructions stored in the at least one memory module cause the electronic control unit to determine a smart elbow position and determine whether the smart elbow position is within a boundary or geofence of a distribution tank including a same fuel type as the liquid product. The machine readable instructions further case the electronic control unit to, in response to a determination that the smart elbow position is within the boundary or geofence of the distribution tank of a same fuel type as the liquid product, permit the liquid product to flow from the tank compartment of the product delivery vehicle to the distribution tank, and in response to a determination that the smart elbow position is outside the boundary or geofence of the distribution tank of the same fuel type as the liquid product, prevent the liquid product from flowing from the tank compartment of the product delivery vehicle to the distribution tank.

In yet another embodiment of the present disclosure, a method for loading a liquid product includes determining a smart elbow position based on a signal output of a sensor of a smart elbow, wherein the smart elbow is configured to be fluidly coupled to a tank compartment of a product delivery vehicle and determining whether the smart elbow position is within a boundary or geofence of a distribution tank including a same fuel type as a liquid product, wherein the liquid product is stored in the tank compartment of the product delivery vehicle. The method further includes permitting the liquid product to flow from the tank compartment of the product delivery vehicle to the distribution tank in response to determining that the smart elbow position is within the boundary or geofence of the distribution tank of the same fuel type as the liquid product, and preventing the liquid product from flowing from the tank compartment of the product delivery vehicle to the distribution tank in response to a determination that the smart elbow position is outside the boundary or geofence of the distribution tank of the same fuel type as the liquid product.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a product delivery vehicle, smart elbow, and delivery hoses, according to one or more embodiments of the present disclosure;

FIG. 2 schematically depicts an air system of the product delivery vehicle of FIG. 1, according to one or more embodiments of the present disclosure;

FIG. 3 schematically depicts various electronic components of a crossover protection system, a first smart elbow, and a second smart elbow, according to one or more embodiments of the present disclosure;

FIG. 4 schematically depicts a diagram of a network interface hardware of the crossover protection system of FIG. 3;

FIG. 5A schematically depicts a distribution station, according to one or more embodiments shown and described herein;

FIG. 5B schematically depicts the distribution station of FIG. 5A with geofences mapped on the distribution station, according to one or more embodiments shown and described herein;

FIG. 6 schematically depicts a graphical user interface of a display device, according to one or more embodiments shown and described herein; and

FIG. 7 schematically depicts a distributed computing environment of the crossover protection system of FIG. 1, according to one or more embodiments shown and described herein.

### DETAILED DESCRIPTION

A product delivery vehicle (e.g., a fuel truck) may deliver a liquid product (e.g., gasoline or diesel fuel) from a tank compartment to a distribution tank (e.g., an underground distribution tank containing gasoline or an underground distribution tank containing diesel fuel) at a distribution station (e.g., a gas station). Such product delivery vehicles may include multiple tank compartments, each of which contains a different liquid (e.g., a gasoline tank compartment, a diesel tank compartment, etc.). Several distribution tanks may be located at the distribution station, such as a gasoline distribution tank, a diesel distribution tank, etc. The product delivery vehicle may include a crossover protection system to prevent crossover, cross contamination, or co-mingling of a liquid from the tank compartment of the product delivery vehicle into a distribution tank that contains a different liquid. The crossover protection system may include a smart elbow fluidly coupled to the tank compartment of the product delivery vehicle and communicatively coupled to an electronic control unit of the product delivery vehicle. The crossover protection system may also include machine readable instructions on the electronic control unit that cause a processor to determine a smart elbow position and determine whether the smart elbow is within a boundary or geofence of a distribution tank with the same fuel type as the liquid product. Machine readable instructions may further be included such that when the processor determines that the smart elbow is within the boundary of geofence of the distribution tank of same fuel type as the liquid product the liquid product is allowed to flow from the tank compartment to the distribution tank. Machine readable instructions may further be included such that when the processor determines that the smart elbow outside the boundary of geofence of the distribution tank of same fuel type as the liquid product, the liquid product is prevented to flow from the tank compartment to the distribution tank.

Embodiments described herein include crossover protection systems with a smart elbow to deliver liquid products. In one or more embodiments, a crossover protection system may include a processor, a network interface hardware communicatively coupled to the processor, at least one memory module communicatively coupled to the processor, and machine readable instructions stored in the at least one memory module. The machine readable instructions stored in the at least one memory module may cause the processor to perform various functions, such as but not limited to determine a smart elbow position based on a signal output of a sensor of a smart elbow. The smart elbow may be configured to be fluidly coupled to a tank compartment of a product delivery vehicle and the liquid product may stored in the tank compartment of the product delivery vehicle. The machine readable instructions may further cause the processor to determine whether the smart elbow position is within a boundary or geofence of a distribution tank including a same fuel type as a liquid product and, in response to a determination that the smart elbow position is within the boundary or geofence of the distribution tank of the same fuel type as the liquid product, the processor may allow the liquid product to flow from the tank compartment of the product delivery vehicle to the distribution tank. The machine readable instructions may further cause the processor to, in response to a determination that the smart elbow position is outside the boundary or geofence of the distribution tank of the same fuel type as the liquid product, prevent the liquid product from flowing from the tank compartment of the product delivery vehicle to the distribution tank.

The crossover protection systems disclosed herein allow for a position-based determination of whether the tank compartment is fluidly coupled to the distribution tank at a distribution station of the same fuel type as the liquid product. Boundaries of geofences corresponding to certain fuel types may be drawn around distribution tanks. The crossover protection system may be communicatively coupled to a location system at the distribution station, a fleet management system, and/or a cloud system, from which the boundary or geofence may be received. This allows for the crossover protection system to be updated with boundary and geofence positions at various distribution stations. In a non-limiting example, once the smart elbow fluidly couples the tank compartment and to the distribution tank, if the smart elbow is within a boundary or geofence of the distribution tank of same fuel type as the liquid product in the tank compartment, the liquid product is permitted to flow into the distribution tank. On the other hand, if the smart elbow is outside the boundary or geofence of the distribution tank of the same fuel type as the liquid product, the liquid product is prevented from flowing into the distribution tank. This prevents the accidental flow of the liquid product of a certain fuel type into a distribution tank of a different fuel type, which may lead to fuel contamination and, thus, costly cleaning and/or replacement of the distribution tank.

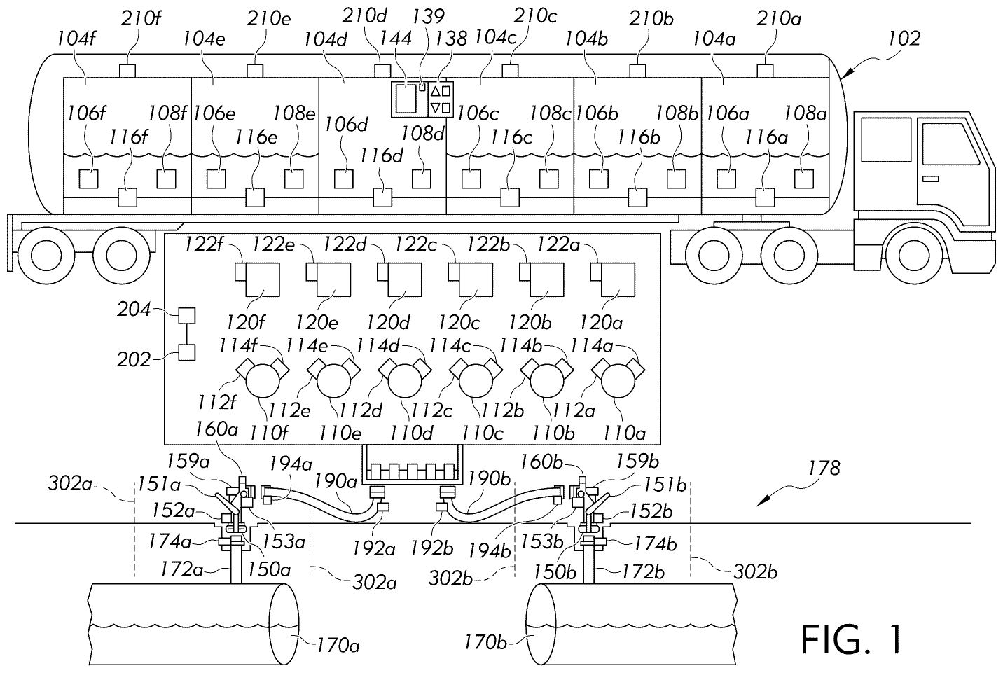

Referring now to FIG. 1, a product delivery vehicle 102 is depicted that may deliver liquid products from tank compartments 104 of the product delivery vehicle 102 to a first distribution tank 170a and a second distribution tank 170b at a distribution station 178. FIG. 1 also depicts a first delivery hose 190a, a second delivery hose 190b, a first smart elbow 150a, and a second smart elbow 150b, which may be utilized to facilitate the delivery of fluid from the product delivery vehicle 102 to the first distribution tank 170a and/or the second distribution tank 170b, as will be described further below. The first smart elbow 150a and the second smart elbow 150b may be fluidly coupled to the tank compartment 104 of the product delivery vehicle 102, such as through the first delivery hose 190a and the second delivery hose 190b, respectively. The various components of the product delivery vehicle 102, the first delivery hose 190a, the second delivery hose 190b, the first distribution tank 170a, the second distribution tank 170b, the first smart elbow 150a, and the second smart elbow 150b, will be described herein.

Still referring to FIG. 1, the product delivery vehicle 102 may include one or a plurality of tank compartments 104, such as tank compartments 104a, . . . , 104f, one or a plurality of control valves, such as control valves 110a, . . . , 110f, one or a plurality of control valve sensors 112a, . . . , 112f, one or a plurality of hose tag readers 114a, . . . , 114f, one or a plurality of internal valves, such as internal valves 116a, . . . , 116f, one or a plurality of solenoid valves 120a, . . . , 120f, one or a plurality of solenoid valve sensors 122a, . . . , 122f, a main air input connection 202, a main air valve 204, user input device 138, a magnet 139, and a display 144. The product delivery vehicle 102 may also include one or a plurality of fluid property sensors, such as fluid property sensors 106a, . . . , 106f, one or a plurality of pressure sensors, such as pressure sensors 108a, . . . , 108f, or one or a plurality of overfill sensors, such as overfill sensors 210a, . . . , 210f. The various components and relationships thereof of the product delivery vehicle 102 will now be described.

Still referring to the product delivery vehicle 102 of FIG. 1, the tank compartments 104a, . . . , 104f may include a first tank compartment 104a, a second tank compartment 104b, a third tank compartment 104c, a fourth tank compartment 104d, a fifth tank compartment 104e, and a sixth tank compartment 104f. In other embodiments, the product delivery vehicle 102 may include more than or less than six tank compartments. Each of the tank compartments may contain a liquid product, such as a particular type of fuel, to be delivered to the distribution tanks 170a, 170b at the distribution station 178. The tank compartments 104 may be fluidly coupled to the distribution tanks 170 through the smart elbows 150, as described further herein.

Still referring to FIG. 1, the fluid property sensors (FPS) 106a, . . . , 106f may include one or more of a first fluid property sensor 106a, a second fluid property sensor 106b, a third fluid property sensor 106c, a fourth fluid property sensor 106d, a fifth fluid property sensor 106e, and/or a sixth fluid property sensor 106f. The first fluid property sensor 106a may be associated with the first tank compartment 104a. The first fluid property sensor 106a may be positioned to contact fluid contained within the first tank compartment 104a and to output a signal indicative of a sensed fluid property (e.g., viscosity, density, dielectric constant, transmissivity, fluorescence, temperature, etc.) of the fluid contained within the first tank compartment 104a. In embodiments, the first fluid property sensor 106a may be positioned in the first tank compartment 104a. In embodiments, the first fluid property sensor 106a may be positioned in a pipe or conduit fluidly coupled to the first tank compartment 104a, such as a pipe fluidly coupled to a bottom of the first tank compartment 104a.

The second fluid property sensor 106b may be associated with the second tank compartment 104b. The second fluid property sensor 106b may be positioned to contact fluid contained within the second tank compartment 104b and to output a signal indicative of a sensed fluid property (e.g., viscosity, density, dielectric constant, transmissivity, fluorescence, temperature, etc.) of the fluid contained within the second tank compartment 104b. In embodiments, the second fluid property sensor 106b may be positioned in the second tank compartment 104b. In embodiments, the second fluid property sensor 106b may be positioned in a pipe or conduit fluidly coupled to the second tank compartment 104b, such as a pipe fluidly coupled to a bottom of the second tank compartment 104b.

The third fluid property sensor 106c may be associated with the third tank compartment 104c. The third fluid property sensor 106c may be positioned to contact fluid contained within the third tank compartment 104c and to output a signal indicative of a sensed fluid property (e.g., viscosity, density, dielectric constant, transmissivity, fluorescence, temperature, etc.) of the fluid contained within the third tank compartment 104c. In embodiments, the third fluid property sensor 106c may be positioned in the third tank compartment 104c. In embodiments, the third fluid property sensor 106c may be positioned in a pipe or conduit fluidly coupled to the third tank compartment 104c, such as a pipe fluidly coupled to a bottom of the third tank compartment 104c.

The fourth fluid property sensor 106d may be associated with the fourth tank compartment 104d. The fourth fluid property sensor 106d may be positioned to contact fluid contained within the fourth tank compartment 104d and to output a signal indicative of a sensed fluid property (e.g., viscosity, density, dielectric constant, transmissivity, fluorescence, temperature, etc.) of the fluid contained within the fourth tank compartment 104d. In embodiments, the fourth fluid property sensor 106d may be positioned in the fourth tank compartment 104d. In embodiments, the fourth fluid property sensor 106d may be positioned in a pipe or conduit fluidly coupled to the fourth tank compartment 104d, such as a pipe fluidly coupled to a bottom of the fourth tank compartment 104d.

The fifth fluid property sensor 106e may be associated with the fifth tank compartment 104e. The fifth fluid property sensor 106e may be positioned to contact fluid contained within the fifth tank compartment 104e and to output a signal indicative of a sensed fluid property (e.g., viscosity, density, dielectric constant, transmissivity, fluorescence, temperature, etc.) of the fluid contained within the fifth tank compartment 104e. In embodiments, the fifth fluid property sensor 106e may be positioned in the fifth tank compartment 104e. In embodiments, the fifth fluid property sensor 106e may be positioned in a pipe or conduit fluidly coupled to the fifth tank compartment 104e, such as a pipe fluidly coupled to a bottom of the fifth tank compartment 104e.

The sixth fluid property sensor 106f may be associated with the sixth tank compartment 104f. The sixth fluid property sensor 106f may be positioned to contact fluid contained within the sixth tank compartment 104f and to output a signal indicative of a sensed fluid property (e.g., viscosity, density, dielectric constant, transmissivity, fluorescence, temperature, etc.) of the fluid contained within the sixth tank compartment 104f. In embodiments, the sixth fluid property sensor 106f may be positioned in the sixth tank compartment 104f. In embodiments, the sixth fluid property sensor 106f may be positioned in a pipe or conduit fluidly coupled to the sixth tank compartment 104f, such as a pipe fluidly coupled to a bottom of the sixth tank compartment 104f.

In embodiments, one or more of the plurality of fluid property sensors 106a, . . . , 106f may be a fluid property sensor as described in U.S. Pat. No. 9,823,665, granted Nov. 21, 2017, entitled “Cross Contamination Control Systems with Fluid Product ID Sensors,” the entirety of which is incorporated herein by reference. In embodiments, one or more of the plurality of fluid property sensors 106a, . . . , 106f is a tuning fork sensor model number FPS2800B12C4 by Measurement Specialties. In other embodiments, one or more than one of the fluid property sensors 106a, . . . , 106f may be an optical fluid sensor as described in U.S. Pat. No. 10,407,296, granted filed Sep. 10, 2019, entitled “Optical Fluid Sensors for Cross Contamination Control Systems,” the entirety of which is incorporated herein by reference. However, it should be understood that other alternative fluid property sensors capable of determining the type of fluid in the tank compartments 104a, . . . , 104f could be used.

Still referring to FIG. 1, the pressure sensors 108a, . . . , 108f may include one or more of a first pressure sensor 108a, a second pressure sensor 108b, a third pressure sensor 108c, a fourth pressure sensor 108d, a fifth pressure sensor 108e, and/or a sixth pressure sensor 108f. The first pressure sensor 108a may be associated with the first tank compartment 104a. The first pressure sensor 108a may output a signal indicative of a sensed pressure within the first tank compartment 104a, which may be utilized to gauge the approximate level or amount of liquid in the first tank compartment 104a. In embodiments, the first pressure sensor 108a may be positioned in the first tank compartment 104a. In embodiments, the first pressure sensor 108a may be positioned in a pipe or conduit fluidly coupled to the first tank compartment 104a, such as a pipe fluidly coupled to a bottom of the first tank compartment 104a.

The second pressure sensor 108b may be associated with the second tank compartment 104b. The second pressure sensor 108b may output a signal indicative of a sensed pressure within the second tank compartment 104b, which may be utilized to gauge the approximate level or amount of liquid in the second tank compartment 104b. In embodiments, the second pressure sensor 108b may be positioned in the second tank compartment 104b. In embodiments, the second pressure sensor 108b may be positioned in a pipe or conduit fluidly coupled to the second tank compartment 104b, such as a pipe fluidly coupled to a bottom of the second tank compartment 104b.

The third pressure sensor 108c may be associated with the third tank compartment 104c. The third pressure sensor 108c may output a signal indicative of a sensed pressure within the third tank compartment 104c, which may be utilized to gauge the approximate level or amount of liquid in the third tank compartment 104c. In embodiments, the third pressure sensor 108c may be positioned in the third tank compartment 104c. In embodiments, the third pressure sensor 108c may be positioned in a pipe or conduit fluidly coupled to the third tank compartment 104c, such as a pipe fluidly coupled to a bottom of the third tank compartment 104c.

The fourth pressure sensor 108d may be associated with the fourth tank compartment 104d. The fourth pressure sensor 108d may output a signal indicative of a sensed pressure within the fourth tank compartment 104d, which may be utilized to gauge the approximate level or amount of liquid in the fourth tank compartment 104d. In embodiments, the fourth pressure sensor 108d may be positioned in the fourth tank compartment 104d. In embodiments, the fourth pressure sensor 108d may be positioned in a pipe or conduit fluidly coupled to the fourth tank compartment 104d, such as a pipe fluidly coupled to a bottom of the fourth tank compartment 104d.

The fifth pressure sensor 108e may be associated with the fifth tank compartment 104e. The fifth pressure sensor 108e may output a signal indicative of a sensed pressure within the fifth tank compartment 104e, which may be utilized to gauge the approximate level or amount of liquid in the fifth tank compartment 104e. In embodiments, the fifth pressure sensor 108e may be positioned in the fifth tank compartment 104e. In embodiments, the fifth pressure sensor 108e may be positioned in a pipe or conduit fluidly coupled to the fifth tank compartment 104e, such as a pipe fluidly coupled to a bottom of the fifth tank compartment 104e.

The sixth pressure sensor 108f may be associated with the sixth tank compartment 104f. The sixth pressure sensor 108f may output a signal indicative of a sensed pressure within the sixth tank compartment 104f, which may be utilized to gauge the approximate level or amount of liquid in the sixth tank compartment 104f. In embodiments, the sixth pressure sensor 108f may be positioned in the sixth tank compartment 104f. In embodiments, the sixth pressure sensor 108f may be positioned in a pipe or conduit fluidly coupled to the sixth tank compartment 104f, such as a pipe fluidly coupled to a bottom of the sixth tank compartment 104f.

In embodiments, one or more of the plurality of pressure sensors 108a, . . . , 108f may be a pressure sensor as described in U.S. Pat. No. 9,823,665, previously cited in this disclosure. In embodiments, one or more of the plurality of pressure sensors 108a, . . . , 108f may be a diaphragm pressure sensor, model number 1E/F by Televac. However, it should be understood that alternative pressure sensors may be used, such as, for example, a piezo pressure sensor or an electric pressure sensor.

Still referring to FIG. 1, the pressure sensors 108a, . . . , 108f may include one or more of a first pressure sensor 108a, a second pressure sensor 108b, a third pressure sensor 108c, a fourth pressure sensor 108d, a fifth pressure sensor 108e, and/or a sixth pressure sensor 108f. The first pressure sensor 108a may be associated with the first tank compartment 104a. The first pressure sensor 108a may output a signal indicative of a sensed pressure within the first tank compartment 104a, which may be utilized to gauge the approximate level or amount of liquid in the first tank compartment 104a. In embodiments, the first pressure sensor 108a may be positioned in the first tank compartment 104a. In embodiments, the first pressure sensor 108a may be positioned in a pipe or conduit fluidly coupled to the first tank compartment 104a, such as a pipe fluidly coupled to a bottom of the first tank compartment 104a.

The second pressure sensor 108b may be associated with the second tank compartment 104b. The second pressure sensor 108b may output a signal indicative of a sensed pressure within the second tank compartment 104b, which may be utilized to gauge the approximate level or amount of liquid in the second tank compartment 104b. In embodiments, the second pressure sensor 108b may be positioned in the second tank compartment 104b. In embodiments, the second pressure sensor 108b may be positioned in a pipe or conduit fluidly coupled to the second tank compartment 104b, such as a pipe fluidly coupled to a bottom of the second tank compartment 104b.

The third pressure sensor 108c may be associated with the third tank compartment 104c. The third pressure sensor 108c may output a signal indicative of a sensed pressure within the third tank compartment 104c, which may be utilized to gauge the approximate level or amount of liquid in the third tank compartment 104c. In embodiments, the third pressure sensor 108c may be positioned in the third tank compartment 104c. In embodiments, the third pressure sensor 108c may be positioned in a pipe or conduit fluidly coupled to the third tank compartment 104c, such as a pipe fluidly coupled to a bottom of the third tank compartment 104c.

The fourth pressure sensor 108d may be associated with the fourth tank compartment 104d. The fourth pressure sensor 108d may output a signal indicative of a sensed pressure within the fourth tank compartment 104d, which may be utilized to gauge the approximate level or amount of liquid in the fourth tank compartment 104d. In embodiments, the fourth pressure sensor 108d may be positioned in the fourth tank compartment 104d. In embodiments, the fourth pressure sensor 108d may be positioned in a pipe or conduit fluidly coupled to the fourth tank compartment 104d, such as a pipe fluidly coupled to a bottom of the fourth tank compartment 104d.

The fifth pressure sensor 108e may be associated with the fifth tank compartment 104e. The fifth pressure sensor 108e may output a signal indicative of a sensed pressure within the fifth tank compartment 104e, which may be utilized to gauge the approximate level or amount of liquid in the fifth tank compartment 104e. In embodiments, the fifth pressure sensor 108e may be positioned in the fifth tank compartment 104e. In embodiments, the fifth pressure sensor 108e may be positioned in a pipe or conduit fluidly coupled to the fifth tank compartment 104e, such as a pipe fluidly coupled to a bottom of the fifth tank compartment 104e.

The sixth pressure sensor 108f may be associated with the sixth tank compartment 104f. The sixth pressure sensor 108f may output a signal indicative of a sensed pressure within the sixth tank compartment 104f, which may be utilized to gauge the approximate level or amount of liquid in the sixth tank compartment 104f. In embodiments, the sixth pressure sensor 108f may be positioned in the sixth tank compartment 104f. In embodiments, the sixth pressure sensor 108f may be positioned in a pipe or conduit fluidly coupled to the sixth tank compartment 104f, such as a pipe fluidly coupled to a bottom of the sixth tank compartment 104f.

In embodiments, one or more of the plurality of pressure sensors 108a, . . . , 108f may be a pressure sensor as described in U.S. Pat. No. 9,823,665, previously cited in this disclosure. In embodiments, one or more of the plurality of pressure sensors 108a, . . . , 108f may be a diaphragm pressure sensor, model number 1E/F by Televac. However, it should be understood that alternative pressure sensors may be used, such as, for example, a piezo pressure sensor or an electric pressure sensor.

Still referring to FIG. 1, the overfill sensors 210a, . . . , 210f may include one or more of a first overfill sensor 210a, a second overfill sensor 210b, a third overfill sensor 210c, a fourth overfill sensor 210d, a fifth overfill sensor 210e, and/or a sixth overfill sensor 210f. The first overfill sensor 210a may be associated with the first tank compartment 104a. The first overfill sensor 210a may be operable to determine an overfill condition in the first tank compartment 104a. The first overfill sensor 210a may output or transmit a signal indicative of an overfill condition within the first tank compartment 104a. In embodiments, the first overfill sensor 210a may be operable to determine a liquid level in the first tank compartment 104a and output or transmit a signal indicative of the liquid level of fluid in the first tank compartment 104a. In embodiments, the first overfill sensor 210a may be positioned in a top portion of the first tank compartment 104a.

The second overfill sensor 210b may be associated with the second tank compartment 104b. The second overfill sensor 210b may be operable to determine an overfill condition in the second tank compartment 104b. The second overfill sensor 210b may output or transmit a signal indicative of an overfill condition within the second tank compartment 104b. In embodiments, the second overfill sensor 210b may be operable to determine a liquid level in the second tank compartment 104b and output or transmit a signal indicative of the liquid level of fluid in the second tank compartment 104b. In embodiments, the second overfill sensor 210b may be positioned in a top portion of the second tank compartment 104b.

The third overfill sensor 210c may be associated with the third tank compartment 104c. The third overfill sensor 210c may be operable to determine an overfill condition in the third tank compartment 104c. The third overfill sensor 210c may output or transmit a signal indicative of an overfill condition within the third tank compartment 104c. In embodiments, the third overfill sensor 210c may be operable to determine a liquid level in the third tank compartment 104c and output or transmit a signal indicative of the liquid level of fluid in the third tank compartment 104c. In embodiments, the third overfill sensor 210c may be positioned in a top portion of the third tank compartment 104c.

The fourth overfill sensor 210d may be associated with the fourth tank compartment 104d. The fourth overfill sensor 210d may be operable to determine an overfill condition in the fourth tank compartment 104d. The fourth overfill sensor 210d may output or transmit a signal indicative of an overfill condition within the fourth tank compartment 104d. In embodiments, the fourth overfill sensor 210d may be operable to determine a liquid level in the fourth tank compartment 104d and output or transmit a signal indicative of the liquid level of fluid in the fourth tank compartment 104d. In embodiments, the fourth overfill sensor 210d may be positioned in a top portion of the fourth tank compartment 104d.

The fifth overfill sensor 210e may be associated with the fifth tank compartment 104e. The fifth overfill sensor 210e may be operable to determine an overfill condition in the fifth tank compartment 104e. The fifth overfill sensor 210e may output or transmit a signal indicative of an overfill condition within the fifth tank compartment 104e. In embodiments, the fifth overfill sensor 210e may be operable to determine a liquid level in the fifth tank compartment 104e and output or transmit a signal indicative of the liquid level of fluid in the fifth tank compartment 104e. In embodiments, the fifth overfill sensor 210e may be positioned in a top portion of the fifth tank compartment 104e.

The sixth overfill sensor 210f may be associated with the sixth tank compartment 104f. The sixth overfill sensor 210f may be operable to determine an overfill condition in the sixth tank compartment 104f. The sixth overfill sensor 210f may output or transmit a signal indicative of an overfill condition within the sixth tank compartment 104f. In embodiments, the sixth overfill sensor 210f may be operable to determine a liquid level in the sixth tank compartment 104f and output or transmit a signal indicative of the liquid level of fluid in the sixth tank compartment 104f. In embodiments, the sixth overfill sensor 210f may be positioned in a top portion of the sixth tank compartment 104f.

In embodiments, one or more of the plurality of overfill sensors 210a, . . . , 210f may be an overfill probe as described in U.S. Pat. No. 8,593,290, granted Nov. 26, 2013, entitled “Overfill Detection System for Tank Trucks,” the entirety of which is incorporated herein by reference. However, it should be understood that other alternative overfill sensors may be used. In embodiments, one or more of the plurality of overfill sensors 210a, . . . , 210f may be a level probe, such as point level probe or a continuous level probe. Examples of level probes may include, but are not limited to, ultrasonic, optical, microwave, capacitance, nuclear, or mechanical level probes, or other types of level probe.

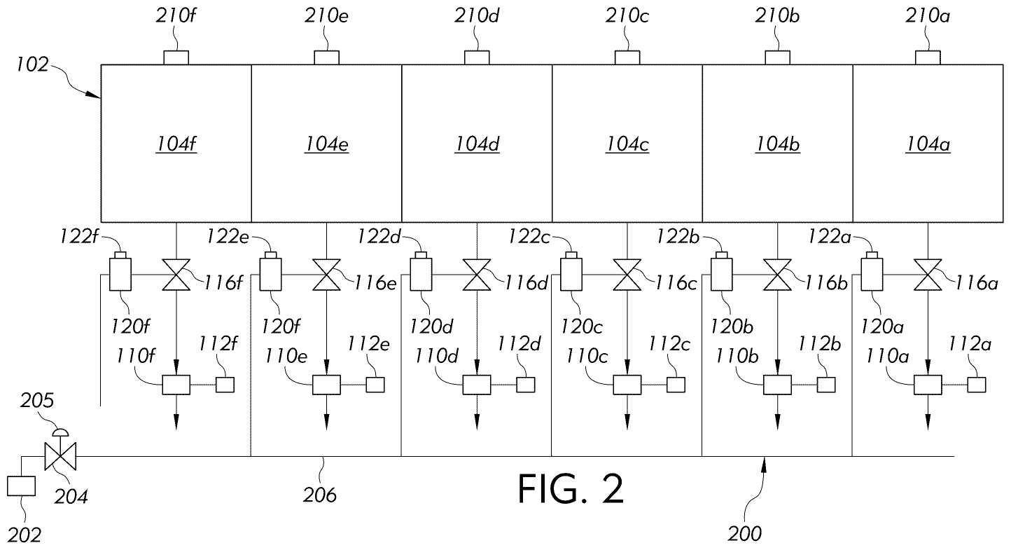

Still referring to FIGS. 1 and 2, the plurality of internal valves 116a, . . . , 116f may include a first internal valve 116a, a second internal valve 116b, a third internal valve 116c, a fourth internal valve 116d, a fifth internal valve 116e, and a sixth internal valve 116f. The first internal valve 116a may be fluidly coupled to the first tank compartment 104a and may control the release of fluid, such as a liquid product, from the first tank compartment 104a. For example, the fluid may be released from the first tank compartment 104a when the first internal valve 116a is in an open configuration, and fluid may not be released from the first tank compartment 104a when the first internal valve 116a is in a closed configuration. In some embodiments, the first internal valve 116a may have a normally closed configuration. In some embodiments, the first internal valve 116a may be an air operated valve and may be operatively coupled to the air system of the product delivery vehicle 102. In some embodiments, the first internal valve 116a may be an emergency valve.

The second internal valve 116b may be fluidly coupled to the second tank compartment 104b and may control the release of fluid, such as a liquid product, from the second tank compartment 104b. For example, the fluid may be released from the second tank compartment 104b when the second internal valve 116b is in an open configuration, and fluid may not be released from the second tank compartment 104b when the second internal valve 116b is in a closed configuration. In some embodiments, the second internal valve 116b may have a normally closed configuration. In some embodiments, the second internal valve 116b may be an air operated valve and may be operatively coupled to the air system of the product delivery vehicle 102. In some embodiments, the second internal valve 116b may be an emergency valve.

The third internal valve 116c may be fluidly coupled to the third tank compartment 104c and may control the release of fluid, such as a liquid product, from the third tank compartment 104c. For example, the fluid may be released from the third tank compartment 104c when the third internal valve 116c is in an open configuration, and fluid may not be released from the third tank compartment 104c when the third internal valve 116c is in a closed configuration. In some embodiments, the third internal valve 116c may have a normally closed configuration. In some embodiments, the third internal valve 116c may be an air operated valve and may be operatively coupled to the air system of the product delivery vehicle 102. In some embodiments, the third internal valve 116c may be an emergency valve.

The fourth internal valve 116d may be fluidly coupled to the fourth tank compartment 104d and may control the release of fluid, such as a liquid product, from the fourth tank compartment 104d. For example, the fluid may be released from the fourth tank compartment 104d when the fourth internal valve 116d is in an open configuration, and fluid may not be released from the fourth tank compartment 104d when the fourth internal valve 116d is in a closed configuration. In some embodiments, the fourth internal valve 116d may have a normally closed configuration. In some embodiments, the fourth internal valve 116d may be an air operated valve and may be operatively coupled to the air system of the product delivery vehicle 102. In some embodiments, the fourth internal valve 116d may be an emergency valve.

The fifth internal valve 116e may be fluidly coupled to the fifth tank compartment 104e and may control the release of fluid, such as a liquid product, from the fifth tank compartment 104e. For example, the fluid may be released from the fifth tank compartment 104e when the fifth internal valve 116e is in an open configuration, and fluid may not be released from the fifth tank compartment 104e when the fifth internal valve 116e is in a closed configuration. In some embodiments, the fifth internal valve 116e may have a normally closed configuration. In some embodiments, the fifth internal valve 116e may be an air operated valve and may be operatively coupled to the air system of the product delivery vehicle 102. In some embodiments, the fifth internal valve 116e may be an emergency valve.

The sixth internal valve 116f may be fluidly coupled to the sixth tank compartment 104f and may control the release of fluid, such as a liquid product, from the sixth tank compartment 104f. For example, the fluid may be released from the sixth tank compartment 104f when the sixth internal valve 116f is in an open configuration, and fluid may not be released from the sixth tank compartment 104f when the sixth internal valve 116f is in a closed configuration. In some embodiments, the sixth internal valve 116f may have a normally closed configuration. In some embodiments, the sixth internal valve 116f may be an air operated valve and may be operatively coupled to the air system of the product delivery vehicle 102. In some embodiments, the sixth internal valve 116f may be an emergency valve. In some embodiments, one or more of the plurality of control valves 110a, . . . , 110f may be an emergency valve, such as one of the MaxAir series of internal valves by Civacon.

Referring to FIG. 2, the air system 200 of the product delivery vehicle 102 may include a main air inlet connection 202, a main air valve 204, a manifold 206 fluidly coupled to the main air valve 204, and the one or a plurality of solenoid valves 120a, . . . , 120f fluidly coupled to the manifold 206. The main air inlet connection 202 may be couplable to a compressed gas source, such as a source of compressed air, or other compressed gas. As used herein, the term “compressed air” is meant to include other gases having compositions that are not the same as air, such as carbon dioxide, nitrogen, argon, inert gases, non-combustible gases, other gases or combinations of gases. The main air valve 204 may be in fluid communication with the main air inlet connection 202. In some embodiments, the main air valve 204 may include an actuator 205 operative to transition the main air valve 204 between an open configuration and a closed configuration. In some embodiments, the main air valve 204 may have a normally closed configuration such that activation of the actuator 205 transitions the main air valve 204 from the closed configuration to the open configuration and deactivation of the actuator 205 transitions the main air valve 204 from the open configuration back to the closed configuration.

The manifold 206 may include a rigid or flexible conduit in fluid communication with the main air valve 204. The manifold 206 may include a plurality of connections from which the manifold 206 may supply the compressed gas to one or a plurality of devices or systems associated with the product delivery vehicle 102. For example, in some embodiments, each of the connections of the manifold 206 may be fluidly coupled to one of the plurality of solenoid valves 120a, . . . , 120f to supply the compressed air to the solenoid valve.

Still referring to FIG. 2, the plurality of solenoid valves 120a, . . . , 120f may include a first solenoid valve 120a, a second solenoid valve 120b, a third solenoid valve 120c, a fourth solenoid valve 120d, a fifth solenoid valve 120e, and a sixth solenoid valve 120f. In some embodiments, each of the plurality of solenoid valves 120a, . . . , 120f may be a pneumatic solenoid valve operable to actuate one of the plurality of internal valves 116a, . . . , 116f associated with a corresponding tank compartment 104a, . . . , 104f. In some embodiments, each of the plurality of solenoid valves 120a, . . . , 120f may be fluidly coupled to the manifold 206 for providing the compressed air to the solenoid valves 120a, . . . , 120f.

The first solenoid valve 120a may be associated with the first tank compartment 104a and may control the actuation of the first internal valve 116a associated with the first tank compartment 104a. The first solenoid valve 120a may actuate the first internal valve 116a between the closed configuration and the open configuration of the first internal valve 116a. In some embodiments, the first solenoid valve 120a may have a normally closed configuration in which no compressed air is supplied to the first internal valve 116a when no control signal is provided to the first solenoid valve 120a. The first solenoid valve 120a may include a first solenoid valve sensor 122a positioned proximate to the first solenoid valve 120a. The first solenoid valve sensor 122a may be operable to output a signal indicative of a position or configuration of the first solenoid valve 120a, such as a signal indicative of the first solenoid valve 120a being in an open configuration or a closed configuration.

The second solenoid valve 120b may be associated with the second tank compartment 104b and may control the actuation of the second internal valve 116b associated with the second tank compartment 104b. The second solenoid valve 120b may actuate the second internal valve 116b between the closed configuration and the open configuration of the second internal valve 116b. In some embodiments, the second solenoid valve 120b may have a normally closed configuration in which no compressed air is supplied to the second internal valve 116b when no control signal is provided to the second solenoid valve 120b. The second solenoid valve 120b may include a second solenoid valve sensor 122b positioned proximate to the second solenoid valve 120b. The second solenoid valve sensor 122b may be operable to output a signal indicative of a position or configuration of the second solenoid valve 120b, such as a signal indicative of the second solenoid valve 120b being in an open configuration or a closed configuration.

The third solenoid valve 120c may be associated with the third tank compartment 104c and may control the actuation of the third internal valve 116c associated with the third tank compartment 104c. The third solenoid valve 120c may actuate the third internal valve 116c between the closed configuration and the open configuration of the third internal valve 116c. In some embodiments, the third solenoid valve 120c may have a normally closed configuration in which no compressed air is supplied to the third internal valve 116c when no control signal is provided to the third solenoid valve 120c. The third solenoid valve 120c may include a third solenoid valve sensor 122c positioned proximate to the third solenoid valve 120c. The third solenoid valve sensor 122c may be operable to output a signal indicative of a position or configuration of the third solenoid valve 120c, such as a signal indicative of the third solenoid valve 120c being in an open configuration or a closed configuration.

The fourth solenoid valve 120d may be associated with the fourth tank compartment 104d and may control the actuation of the fourth internal valve 116d associated with the fourth tank compartment 104d. The fourth solenoid valve 120d may actuate the fourth internal valve 116d between the closed configuration and the open configuration of the fourth internal valve 116d. In some embodiments, the fourth solenoid valve 120d may have a normally closed configuration in which no compressed air is supplied to the fourth internal valve 116d when no control signal is provided to the fourth solenoid valve 120d. The fourth solenoid valve 120d may include a fourth solenoid valve sensor 122d positioned proximate to the fourth solenoid valve 120d. The fourth solenoid valve sensor 122d may be operable to output a signal indicative of a position or configuration of the fourth solenoid valve 120d, such as a signal indicative of the fourth solenoid valve 120d being in an open configuration or a closed configuration.

The fifth solenoid valve 120e may be associated with the fifth tank compartment 104e and may control the actuation of the fifth internal valve 116e associated with the fifth tank compartment 104e. The fifth solenoid valve 120e may actuate the fifth internal valve 116e between the closed configuration and the open configuration of the fifth internal valve 116e. In some embodiments, the fifth solenoid valve 120e may have a normally closed configuration in which no compressed air is supplied to the fifth internal valve 116e when no control signal is provided to the fifth solenoid valve 120e. The fifth solenoid valve 120e may include a fifth solenoid valve sensor 122e positioned proximate to the fifth solenoid valve 120e. The fifth solenoid valve sensor 122e may be operable to output a signal indicative of a position or configuration of the fifth solenoid valve 120e, such as a signal indicative of the fifth solenoid valve 120e being in an open configuration or a closed configuration.

The sixth solenoid valve 120f may be associated with the sixth tank compartment 104f and may control the actuation of the sixth internal valve 116f associated with the sixth tank compartment 104f. The sixth solenoid valve 120f may actuate the sixth internal valve 116f between the closed configuration and the open configuration of the sixth internal valve 116f. In some embodiments, the sixth solenoid valve 120f may have a normally closed configuration in which no compressed air is supplied to the sixth internal valve 116f when no control signal is provided to the sixth solenoid valve 120f. The sixth solenoid valve 120f may include a sixth solenoid valve sensor 122f positioned proximate to the sixth solenoid valve 120f. The sixth solenoid valve sensor 122f may be operable to output a signal indicative of a position or configuration of the sixth solenoid valve 120f, such as a signal indicative of the sixth solenoid valve 120f being in an open configuration or a closed configuration.

In some embodiments, one or more of the plurality of solenoid valves 120a, . . . , 120f may be a solenoid valve or solenoid valve assembly as described in U.S. Pat. No. 9,823,665, granted Nov. 21, 2017, entitled “Cross Contamination Control Systems With Fluid Product ID Sensors,” and published as U.S. Patent Application Publication No. 2014/0129038, the entirety of which is incorporated herein by reference, though embodiments are not limited thereto.

Still referring to FIG. 2, the plurality of control valves 110a, . . . , 110f may include a first control valve 110a, a second control valve 110b, a third control valve 110c, a fourth control valve 110d, a fifth control valve 110e, and a sixth control valve 110f. The first control valve 110a may be fluidly coupled to the first internal valve 116a, which may be fluidly coupled to the first tank compartment 104a. The first control valve 110a may control the release of fluid from the first tank compartment 104a, such that fluid may be released from the first tank compartment 104a when the first control valve 110a and the first internal valve 116a are in an open configuration and fluid may not be released from the first tank compartment 104a when the first control valve 110a is in a closed configuration. When the first internal valve 116a and the first control valve 110a are both in the open configuration, then the liquid product in the first tank compartment 104a may flow out of the first tank compartment 104a, through the first internal valve 116a, and then through the first control valve 110a. A first control valve sensor 112a may be positioned proximal to the first control valve 110a. The first control valve sensor 112a may output a signal indicative of a position or configuration of the first control valve 110a, such as a signal indicative of the first control valve 110a being in the open configuration or the closed configuration. The first control valve 110a may be opened and closed manually by an operator or automatically (e.g., when the first control valve 110a is actuated by an electronic, pneumatic, magnetic, or electro-mechanical actuator).

The second control valve 110b may be fluidly coupled to the second internal valve 116b, which may be fluidly coupled to the second tank compartment 104b. The second control valve 110b may control the release of fluid from the second tank compartment 104b, such that fluid may be released from the second tank compartment 104b when the second control valve 110b and the second internal valve 116b are in an open configuration and fluid may not be released from the second tank compartment 104b when the second control valve 110b is in a closed configuration. When the second internal valve 116b and the second control valve 110b are both in the open configuration, then the liquid product in the second tank compartment 104b may flow out of the second tank compartment 104b, through the second internal valve 116a, and then through the second control valve 110b. A second control valve sensor 112b may be positioned proximal to the second control valve 110b. The second control valve sensor 112b may output a signal indicative of a position or configuration of the second control valve 110b, such as a signal indicative of the second control valve 110b being in the open configuration or the closed configuration. The second control valve 110b may be opened and closed manually by an operator or automatically (e.g., when the second control valve 110b is actuated by an electronic, pneumatic, magnetic, or electro-mechanical actuator).

The third control valve 110c may be fluidly coupled to the third internal valve 116c, which may be fluidly coupled to the third tank compartment 104c. The third control valve 110c may control the release of fluid from the third tank compartment 104c, such that fluid may be released from the third tank compartment 104c when the third control valve 110c and the third internal valve 116c are in an open configuration and fluid may not be released from the third tank compartment 104c when the third control valve 110c is in a closed configuration. When the third internal valve 116c and the third control valve 110c are both in the open configuration, then the liquid product in the third tank compartment 104c may flow out of the third tank compartment 104c, through the third internal valve 116c, and then through the third control valve 110c. A third control valve sensor 112c may be positioned proximal to the third control valve 110c. The third control valve sensor 112c may output a signal indicative of a position or configuration of the third control valve 110c, such as a signal indicative of the third control valve 110c being in the open configuration or the closed configuration. The third control valve 110c may be opened and closed manually by an operator or automatically (e.g., when the third control valve 110c is actuated by an electronic, pneumatic, magnetic, or electro-mechanical actuator).

The fourth control valve 110d may be fluidly coupled to the fourth internal valve 116d, which may be fluidly coupled to the fourth tank compartment 104d. The fourth control valve 110d may control the release of fluid from the fourth tank compartment 104d, such that fluid may be released from the fourth tank compartment 104d when the fourth control valve 110d and the fourth internal valve 116d are in an open configuration and fluid may not be released from the fourth tank compartment 104d when the fourth control valve 110d is in a closed configuration. When the fourth internal valve 116d and the fourth control valve 110d are both in the open configuration, then the liquid product in the fourth tank compartment 104d may flow out of the fourth tank compartment 104d, through the fourth internal valve 116d, and then through the fourth control valve 110d. A fourth control valve sensor 112d may be positioned proximal to the fourth control valve 110d. The fourth control valve sensor 112d may output a signal indicative of a position or configuration of the fourth control valve 110d, such as a signal indicative of the fourth control valve 110d being in the open configuration or the closed configuration. The fourth control valve 110d may be opened and closed manually by an operator or automatically (e.g., when the fourth control valve 110d is actuated by an electronic, pneumatic, magnetic, or electro-mechanical actuator).

The fifth control valve 110e may be fluidly coupled to the fifth internal valve 116e, which may be fluidly coupled to the fifth tank compartment 104e. The fifth control valve 110e may control the release of fluid from the fifth tank compartment 104e, such that fluid may be released from the fifth tank compartment 104e when the fifth control valve 110e and the fifth internal valve 116e are in an open configuration and fluid may not be released from the fifth tank compartment 104e when the fifth control valve 110e is in a closed configuration. When the fifth internal valve 116e and the fifth control valve 110e are both in the open configuration, then the liquid product in the fifth tank compartment 104e may flow out of the fifth tank compartment 104e, through the fifth internal valve 116e, and then through the fifth control valve 110e. A fifth control valve sensor 112e may be positioned proximal to the fifth control valve 110e. The fifth control valve sensor 112e may output a signal indicative of a position or configuration of the fifth control valve 110e, such as a signal indicative of the fifth control valve 110e being in the open configuration or the closed configuration. The fifth control valve 110e may be opened and closed manually by an operator or automatically (e.g., when the fifth control valve 110e is actuated by an electronic, pneumatic, magnetic, or electro-mechanical actuator).

The sixth control valve 110f may be fluidly coupled to the sixth internal valve 116f, which may be fluidly coupled to the sixth tank compartment 104f. The sixth control valve 110f may control the release of fluid from the sixth tank compartment 104f, such that fluid may be released from the sixth tank compartment 104f when the sixth control valve 110f and the sixth internal valve 116f are in an open configuration and fluid may not be released from the sixth tank compartment 104f when the sixth control valve 110f is in a closed configuration. When the sixth internal valve 116f and the sixth control valve 110f are both in the open configuration, then the liquid product in the sixth tank compartment 104f may flow out of the sixth tank compartment 104f, through the sixth internal valve 116f, and then through the sixth control valve 110f. A sixth control valve sensor 112f may be positioned proximal to the sixth control valve 110f. The sixth control valve sensor 112f may output a signal indicative of a position or configuration of the sixth control valve 110f, such as a signal indicative of the sixth control valve 110f being in the open configuration or the closed configuration. The sixth control valve 110f may be opened and closed manually by an operator or automatically (e.g., when the sixth control valve 110f is actuated by an electronic, pneumatic, magnetic, or electro-mechanical actuator).

In some embodiments, one or more of the plurality of control valves 110a, . . . , 110f may be a control valve as described in U.S. Pat. No. 9,823,665, granted Nov. 21, 2017, entitled “Cross Contamination Control Systems With Fluid Product ID Sensors,” and published as U.S. Patent Application Publication No. 2014/0129038, the entirety of which is incorporated herein by reference. In some embodiments, one or more of the plurality of control valves 110a, . . . , 110f may be an API Adaptor, model number 891BA-LK by Civacon, though embodiments are not limited thereto.

Each of the control valves 110a, . . . , 110f may include a control valve lever that is coupled to the control valve 110 and used by the operator to manually (e.g. physically) transition the control valve 110 from a normally closed configuration to an open configuration. A lock, such as a pneumatic or electronic lock mechanism, may be coupled to the body of the control valve 110. The lock, when enabled by an electronic control unit 130 or the processor 132 of the electronic control unit 130 (described further below), may allow the control valve 110 to be transition from the normally locked state to the unlocked state, thereby enabling the operator to open the control valve 110 using the control valve lever. The lock may be coupled to the control valve lever internal to the body of the control valve 110 and may mechanically restrict (i.e. stop) the movement of the control valve 110 when in the normally locked state.

Referring again to FIG. 1, the plurality of hose tag readers 114a, . . . , 114f may include a first hose tag reader 114a, a second hose tag reader 114b, a third hose tag reader 114c, a fourth hose tag reader 114d, a fifth hose tag reader 114e, and a sixth hose tag reader 114f. The first hose tag reader 114a may be associated with the first tank compartment 104a. In some embodiments, the first hose tag reader 114a may be an RFID tag reader operable to read an RFID tag on an input-end of a delivery hose when the delivery hose is mechanically connected to a connection point on the product delivery vehicle 102 that is in fluid communication with the first tank compartment 104a. The second hose tag reader 114b may be associated with the second tank compartment 104b. In some embodiments, the second hose tag reader 114b may be an RFID tag reader operable to read an RFID tag on the input-end of a delivery hose when the delivery hose is mechanically connected to a connection point on the product delivery vehicle 102 that is in fluid communication with the second tank compartment 104b. The third hose tag reader 114c may be associated with the third tank compartment 104c. In some embodiments, the third hose tag reader 114c may be an RFID tag reader operable to read an RFID tag on the input-end of a delivery hose when the delivery hose is mechanically connected to a connection point on the product delivery vehicle 102 that is in fluid communication with the third tank compartment 104c. The fourth hose tag reader 114d may be associated with the fourth tank compartment 104d. In some embodiments, the fourth hose tag reader 114d may be an RFID tag reader operable to read an RFID tag on the input-end of a delivery hose when the delivery hose is mechanically connected to a connection point on the product delivery vehicle 102 that is in fluid communication with the fourth tank compartment 104d. The fifth hose tag reader 114e may be associated with the fifth tank compartment 104e. In some embodiments, the fifth hose tag reader 114e may be an RFID tag reader operable to read an RFID tag on the input-end of a delivery hose when the delivery hose is mechanically connected to a connection point on the product delivery vehicle 102 that is in fluid communication with the fifth tank compartment 104e. The sixth hose tag reader 114f may be associated with the sixth tank compartment 104f. In some embodiments, the sixth hose tag reader 114f may be an RFID tag reader operable to read an RFID tag on the input-end of a delivery hose when the delivery hose is mechanically connected to a connection point on the product delivery vehicle 102 that is in fluid communication with the sixth tank compartment 104f.

In some embodiments, one or more of the plurality of hose tag readers 114a, . . . , 114f may be a hose tag reader as described in U.S. Pat. No. 9,823,665, granted Nov. 21, 2017, entitled “Cross Contamination Control Systems With Fluid Product ID Sensors,” and published as U.S. Patent Application Publication No. 2014/0129038, the entirety of which is incorporated herein by reference, though embodiments are not limited thereto.

Still referring to FIG. 1, the first delivery hose 190a may include a first input-end hose tag 192a at an input end of the first delivery hose 190a and a first output-end hose tag 194a at an output end of the first delivery hose 190a, at which a first smart elbow 150a is attached. In some embodiments, the input end of the first delivery hose 190a may be configured to be mechanically connected to an interface of the product delivery vehicle 102 that is in fluid communication with one of the plurality of tank compartments 104a, . . . , 104f from which fluid is to be delivered to a distribution tank. The first input-end hose tag 192a may be read by a hose tag reader (e.g., any of the plurality of hose tag readers 114a, . . . , 114f) coupled to the product delivery vehicle 102 proximate to the mechanical connection of the first delivery hose 190a to the product delivery vehicle 102. The output end of the first delivery hose 190a may be configured to be mechanically connected to one of the smart elbows 150a, 150b which in turn may be mechanically connected to an inlet 172a, 172b of one of the distribution tanks 170a, 170b. The first output-end hose tag 194a may be read by a hose tag reader coupled to the smart elbow 150a, 150b proximate to the mechanical connection of the first delivery hose 190a to the smart elbow 150a, 150b. The first delivery hose 190a may be mechanically coupled to the product delivery vehicle 102 and fluidly coupled to one of the distribution tanks 170a, 170b in any manner, including any manner described in U.S. Pat. No. 9,823,665, previously cited in this disclosure, the entirety of which is incorporated herein by reference.

Still referring to FIG. 1, the second delivery hose 190b may include a second input-end hose tag 192b at an input end of the second delivery hose 190b and a second output-end hose tag 194b at an output end of the second delivery hose 190b, at which a second smart elbow 150b is attached. In some embodiments, the input end of the second delivery hose 190b may be configured to be mechanically connectable to an interface of the product delivery vehicle 102 that is in fluid communication with one of the plurality of tank compartments 104a, . . . , 104f from which fluid is to be delivered to the distribution tank 170a, 170b. The second input-end hose tag 192b may be read by a hose tag reader (e.g., any of the plurality of hose tag readers 114a, . . . , 114f) coupled to the product delivery vehicle 102 proximate to the mechanical connection of the second delivery hose 190b to the product delivery vehicle 102. The output end of the second delivery hose 190b may be configured to be mechanically connectable to one of the smart elbows 150a, 150b, which in turn may be mechanically connectable to an inlet 172a, 172b of one of the distribution tanks 170a, 170b. The second output-end hose tag 194b may be read by a hose tag reader. In some embodiments, the hose tag reader may be coupled to the smart elbow 150a, 150b proximate to the mechanical connection of the second delivery hose 190b to the smart elbow 150a, 150b. Alternatively, in other embodiments, the hose tag reader may be independent of the smart elbow 150a, 150b. The second delivery hose 190b may be mechanically coupled to the product delivery vehicle 102 and fluidly coupled to one of the distribution tanks 170a, 170b in any manner, including any manner described in U.S. Pat. No. 9,823,665, previously cited in this disclosure, the entirety of which is incorporated herein by reference.

Still referring to FIG. 1, the first distribution tank 170a may include a first inlet 172a and a first tank tag 174a. In some embodiments, the first tank tag 174a may be an RFID tag that includes an identifier of a liquid stored in the first distribution tank 170a. In some embodiments, the first tank tag 174a may be mechanically coupled to the first inlet 172a. In some embodiments, the first tank tag 174a may be positioned proximate to the first inlet 172a of the first distribution tank 170a. In some embodiments, the first tank tag 174a may be positioned proximate to the first inlet 172a of the first distribution tank 170a such that when one of the smart elbows 150a, 150b is mechanically coupled to the first inlet 172a, a corresponding tag reader of the smart elbow 150a, 150b can read the first tank tag 174a. The second distribution tank 170b may include a second inlet 172b and a second tank tag 174b. In some embodiments, the second tank tag 174b may be an RFID tag that includes an identifier of a liquid stored in the second distribution tank 170b. In some embodiments, the second tank tag 174b may be mechanically coupled to the second inlet 172b. In some embodiments, the second tank tag 174b may be positioned proximate to the second inlet 172b such that when one of the smart elbows 150a, 150b is mechanically coupled to the second inlet 172b, a corresponding tag reader of the smart elbow 150a, 150b can read the second tank tag 174b.

Still referring to FIG. 1, the smart elbow 150a, 150b may include a sensor 160a, 160b for geographical position information. The sensors 160a, 160b may be referred to herein as location sensors 160a, 160b. The location sensors 160a, 160b may send signals to the electronic control unit 130, such that the electronic control unit 130 may determine a smart elbow position, which may be a geographic location of the smart elbow 150a, 150b. Specifically, the electronic control unit 130 may determine whether the smart elbows 150a, 150b are within the boundary or geofence 302a, 302b (referred to collectively as “geofence 302”) of the distribution tank 170 corresponding to a particular fuel type. The location sensor 160a, 160b may be a GNSS (Global Navigation Satellite System, satellite-based positioning, navigation, and timing systems) receiver, or any other suitable receiver to determine the smart elbow's positional information (such as geographical latitude and longitude information).

Still referring to FIG. 1, the first smart elbow 150a may include a first locking lever 151a and a first hose tag reader 153a. In some embodiments, the first smart elbow 150a may also include a first tank tag reader 152a. Alternatively, in other embodiments, the first tank tag reader 152a may be independent of the first smart elbow 150a. The first locking lever 151a may be configured to mechanically secure the first smart elbow 150a to an inlet 172a, 172b of one of the distribution tanks 170a, 170b when the first locking lever 151a is in a locked configuration, such that fluid may flow through the first smart elbow 150a and into the distribution tank 170a, 170b. The first tank tag reader 152a may be configured to read a tank tag 174a, 174b in the vicinity of the inlet 172a, 172b of the distribution tank 170a, 170b to which the first smart elbow 150a is coupled. For example, in some embodiments, the first delivery connector 150a may be coupled to the first inlet 172a of the first distribution tank 170a, and the first tank tag reader 152a may read the first tank tag 174a positioned proximate to the first inlet 172a of the first distribution tank 170a. In some embodiments, the first tank tag reader 152a may be an RFID tag reader, such as in embodiments in which the first tank tag 174a or the second tank tag 174b is an RFID tag. The first hose tag reader 153a may be an RFID tag reader operable to read an RFID tag on an output-end of one of the delivery hoses 190a, 190b when the delivery hose 190a, 190b is mechanically connected to the first smart elbow 150a. In the aforementioned example, the location sensor 160a may send signals to the electronic control unit 130 defining the smart elbow position and the electronic control unit 130 may determine whether the first smart elbow 150a is within the geofence 302 of a particular fuel type to allow/prevent liquid product from flowing through the first smart elbow 150a and into the distribution tank 170a, 170b, as described further herein.

In some embodiments, the first smart elbow 150a may include one or more components of the smart elbows described in U.S. Pat. No. 9,823,665, previously cited in this disclosure, the entirety of which is incorporated herein by reference. In some embodiments, the first smart elbow 150a may include the same mechanical interface components and may be configured to be mechanically coupled to the first delivery hose 190a or the second delivery hose 190b and/or configured to be mechanically coupled to the first distribution tank 170a or the second distribution tank 170b in the manner described in U.S. Pat. No. 9,823,665, previously cited in this disclosure, the entirety of which is incorporated herein by reference.

Still referring to FIG. 1, the second smart elbow 150b may include a second locking lever 151b and a second hose tag reader 153b. In some embodiments, the second smart elbow 150b may also include a second tank tag reader 152b. Alternatively, in other embodiments, the second tank tag reader 152b may be independent of the second smart elbow 150b. The second locking lever 151b may configured to mechanically secure the second smart elbow 150b to the inlet 172a, 172b of one of the distribution tanks 170a, 170b when the second locking lever 151b is in a locked configuration, such that fluid may flow through the second smart elbow 150b and into the distribution tank 170a, 170b. The second tank tag reader 152b may be configured to read a tank tag 174a, 174b positioned proximate to the inlet 172a, 172b of the distribution tank 170a, 170b to which the second smart elbow 150b is coupled. For example, in some embodiments, the second delivery connector 150b may be coupled to the second inlet 172b of the second distribution tank 170b, and the second tank tag reader 152b may read the second tank tag 174b positioned proximate to the second inlet 172b of the second distribution tank 170b. In some embodiments, the second tank tag reader 152b may be an RFID tag reader, such as in embodiments in which the tank tag 174a, 174b is an RFID tag. The second hose tag reader 153b may be an RFID tag reader operable to read an RFID tag on an output-end of one of the delivery hoses 190a, 190b when the delivery hose 190a, 190b is mechanically connected to the second smart elbow 150b. In the aforementioned example, the location sensor 160b may send signals to the electronic control unit 130 defining the smart elbow position and the electronic control unit 130 may determine whether the second smart elbow 150b is within the geofence 302 of a particular fuel type to allow/prevent liquid product from flowing through the second smart elbow 150b and into the distribution tank 170a, 170b, as described further herein.

In some embodiments, the second smart elbow 150b may include one or more components of the smart elbows described in U.S. Pat. No. 9,823,665, previously cited in this disclosure, the entirety of which is incorporated herein by reference. In some embodiments, the second smart elbow 150b may include the same mechanical interface components and is configured to be mechanically coupled to the first delivery hose 190a or the second delivery hose 190b and/or is configured to be mechanically coupled to the first distribution tank 170a or the second distribution tank 170b in the manner described in U.S. Pat. No. 9,823,665, previously cited in this disclosure, the entirety of which is incorporated herein by reference. It is contemplated herein the that the hose tag readers 153 may be used in combination with the location sensors 160, to prevent cross-contamination of liquids at the distribution station 178, as is described further herein.

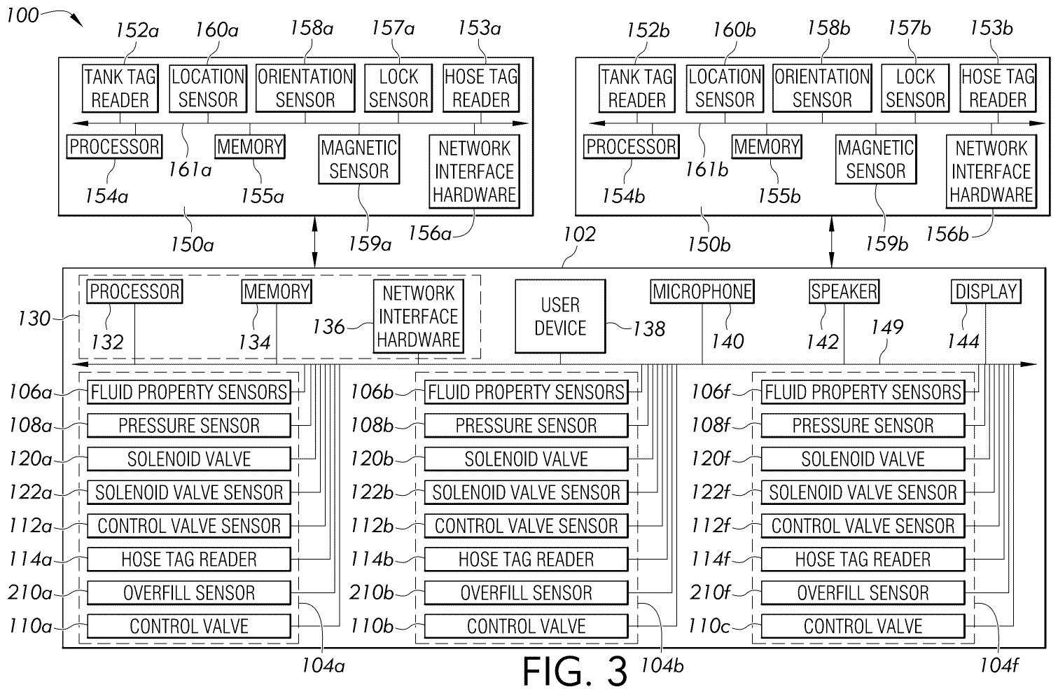

Referring now to FIG. 3, a crossover protection system 100 communicatively coupled to the smart elbow 150 is schematically depicted. The crossover protection system 100 includes the electronic control unit 130, which includes at least a processor 132 and a memory module 134 communicatively coupled to the processor 132. The electronic control unit 130 may also include a network interface hardware 136 communicatively coupled to the processor 132. The crossover protection system 100 may further include a user input device 138, a microphone 140, a speaker 142, a display 144, and a communication path 149. The plurality of fluid property sensors 106a, . . . , 106f, the plurality of pressure sensors 108a, . . . , 108f, the plurality of control valves 110a, . . . , 110f, plurality of control valve locks, plurality of control valve sensors 112a, . . . , 112f, the plurality of hose tag readers 114a, . . . , 114f, the main air valve 204, the plurality of solenoid valves 120a, . . . , 120f, the plurality of solenoid valve sensors 122a, . . . , 122f, and the plurality of overfill sensors 210a, . . . , 210f may be communicatively coupled to the electronic control unit 130 through the communication path 149.

Still referring to FIG. 3, the communication path 149 may be formed from any medium that is capable of transmitting a signal such as, for example, conductive wires, conductive traces, optical waveguides, or the like. Moreover, the communication path 149 may be formed from a combination of mediums capable of transmitting signals. In one embodiment, the communication path 149 comprises a combination of conductive traces, conductive wires, connectors, and buses that cooperate to permit the transmission of electrical data signals to components such as processors, memories, sensors, input devices, output devices, and communication devices. Accordingly, the communication path 149 may comprise a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium. The communication path 149 may communicatively couple the various components of the crossover protection system 100, including the electronic control unit 130 (which includes the processor 132, the memory module 134, and the network interface hardware 136), the user input device 138, the microphone 140, the speaker 142, the display 144, the plurality of fluid property sensors 106a, . . . , 106f, the plurality of pressure sensors 108a, . . . , 108f, the plurality of control valves 110a, . . . , 110f, the plurality of control valve locks, the plurality of control valve sensors 112a, . . . , 112f, the plurality of hose tag readers 114a, . . . , 114f, the main air valve 204, the plurality of solenoid valves 120a, . . . , 120f, the plurality of solenoid valve sensors 122a, . . . , 122f, and the plurality of overfill sensors 210a, . . . , 210f. As used herein, the term “communicatively coupled” means that coupled components are capable of exchanging data signals with one another such as, for example, electrical signals via conductive medium, electromagnetic signals via air, optical signals via optical waveguides, and the like.

Still referring to FIG. 3, the processor 132 may be any device capable of executing machine readable instructions. Accordingly, the processor 132 may be a controller, an integrated circuit, a microchip, a computer, or any other computing device. The processor 132 may be communicatively coupled to the other components of the crossover protection system 100 by the communication path 149. While FIG. 3 shows one processor 132, in other embodiments, multiple processors may be communicatively coupled by the communication path 149. Communicatively coupling the multiple processors by the communication path 149 may allow multiple processors to operate in a distributed computing environment.

Still referring to FIG. 3, the memory module 134 may be coupled to the communication path 149 and communicatively coupled to the processor 132. The memory module 134 may comprise RAM, ROM, flash memories, hard drives, or any device capable of storing machine readable instructions such that the machine readable instructions can be accessed and executed by the processor 132 and, thus, the electronic control unit 130. The machine readable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable instructions and stored on the memory module 134. Alternatively, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

Still referring to FIG. 3, the display 144 may be coupled to the communication path 149 and communicatively coupled to the processor 132. The display 144 may be any device capable of providing visual output such as, for example, a graphical user interface or a schematic representation of the product delivery vehicle 102 and information pertaining to unloading fluid therefrom, such as the geofences 302a, 302b, as described herein. The display 144 may also display information pertaining to loading and/or unloading of fluids to the tank compartments 104 of the product delivery vehicle 102. The display 144 may include any medium capable of transmitting an optical output such as, for example, a cathode ray tube, light emitting diodes, a liquid crystal display, a plasma display, or the like. Moreover, the display 144 may be a touchscreen that, in addition to providing optical information, detects the presence and location of a tactile input upon a surface of or adjacent to the display 144. Accordingly, each display may receive mechanical input directly upon the optical output provided by the display. Thus, a touchscreen may include both the display 144 and the user input device 138. Additionally, it is noted that the display 144 can include one or more processors and one or memory modules. In some embodiments, the display 144 may include the processor 132 and the memory module 134.

Referring again to FIG. 3, the user input device 138 may be coupled to the communication path 149 and communicatively coupled to the processor 132. The user input device 138 may be any device capable of transforming mechanical, optical, electrical signals, or sound waves into a data signal capable of being transmitted with the communication path 149. Specifically, the user input device 138 may include any number of movable objects that each transform physical motion into a data signal that can be transmitted to over the communication path 149 such as, for example, a button, a switch, a knob, a mouse, a joystick, or the like. In some embodiments, the display 144 and the user input device 138 may be combined as a single module and operate as a touchscreen. However, it is noted, that the display 144 and the user input device 138 may be separate from one another and operate as a single module by exchanging signals via the communication path 149.

Still referring to FIG. 3, the speaker 142 may be coupled to the communication path 149 and communicatively coupled to the processor 132. The speaker 142 may transform data signals into mechanical vibrations, such as in order to provide information related to operation of the crossover protection system 100. However, it should be understood that in other embodiments the crossover protection system 100 may not include the speaker 142.

Still referring to FIG. 3, the microphone 140 is coupled to the communication path 149 and communicatively coupled to the processor 132. The microphone 140 may be any device capable of receiving a mechanical vibration at the microphone and transforming the received mechanical vibration into an electrical signal indicative of the received mechanical vibration. The microphone 140 may provide another way for a user to provide input to the crossover protection system 100.

Still referring to FIG. 3, network interface hardware 136 may be coupled to the communication path 149 and communicatively coupled to the processor 132. The network interface hardware 136 may be any device capable of transmitting and/or receiving data via a network. Accordingly, the network interface hardware 136 can include a communication transceiver for sending and/or receiving any wired or wireless communication. For example, the network interface hardware 136 may include an antenna, a modem, LAN port, Wi-Fi card, WiMax card, mobile communications hardware, near-field communication hardware, satellite communication hardware and/or any wired or wireless hardware for communicating with other networks and/or devices. In some embodiments, network interface hardware 136 includes a wireless communication module configured to send and receive wireless communication with other devices. In some embodiments, network interface hardware 136 communicates wirelessly according to the IrDA, Bluetooth, Wireless USB, Z-Wave, ZigBee, and/or any other wireless communication protocols.

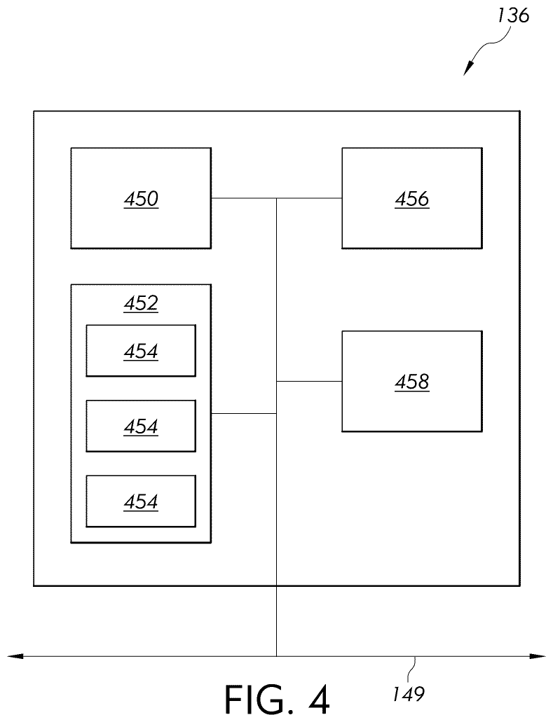

Referring to FIG. 4, the network interface hardware 136 may further include at least one network interface hardware processor 450, one or more network interface hardware storage media 452, a GNSS (Global Navigation Satellite System, satellite-based positioning, navigation, and timing systems) receiver 456, and machine readable instructions 454 stored on the network interface hardware storage media 452. The network interface hardware 136 may be operable to perform computations using input received from other components of the crossover protection system 100, store data in the one or more network interface hardware storage media 452, and provide network connection between the crossover protection system 100 and one or more external systems, such as but not limited to a loading system at a loading station, a location system 171 at the distribution station 178, a fleet management system 520, a cloud system 530, or combinations of these (described further herein below). The machine readable instructions 454 stored on the network interface hardware storage media 452, when executed by the network interface hardware processor 450, may cause the network interface hardware 136 to receive data from the processor 130 or other component of the crossover protection system 100. The data received may include one or more events, alarms, or errors generated by the crossover protection system 100. Events may include loading or unloading actions, such as turning on the main air valve, connecting hoses, opening or closing the control valves or internal valves, or other actions relating to operation of the product delivery vehicle 102. Alarms can include fuel type mismatches, volume mismatches, high pressure, overfill conditions, fault probes, smart elbow-geofence mismatches, or other alarms. Errors may include but are not limited to loose or non-functioning instruments, connectivity outages, or other errors. The machine readable instructions 454, when executed by the network interface hardware processor 450, may combine each event, alarm, or error received from the crossover protection system 100 with a time stamp and geographical position information from the GNSS receiver 456. The machine readable instructions 454, when executed by the network interface hardware processor 450, may cause the network interface hardware 136 to transmit the type of event or alarm, time stamp, and geographical position information to one or more external systems (e.g., loading system, fleet management system, cloud system) through one or more networks.

Referring again to FIG. 3, the first smart elbow 150a may include a first tank tag reader 152a, a first hose tag reader 153a, a first processor 154a, a first memory module 155a, first network interface hardware 156a, a first lock sensor 157a, a first orientation sensor 158a, a first magnetic sensor 159a, a first location sensor 160a, and a first communication path 161a.

Still referring to FIG. 3, the first communication path 161a may be formed from any medium that is capable of transmitting a signal such as, for example, conductive wires, conductive traces, optical waveguides, or the like. Moreover, the first communication path 161a may be formed from a combination of mediums capable of transmitting signals. In some embodiments, the first communication path 161a may comprise a combination of conductive traces, conductive wires, connectors, and buses that cooperate to permit the transmission of electrical data signals to components such as processors, memories, sensors, input devices, output devices, and communication devices. The first communication path 161a may have any other feature or functionality of the communication path 149 previously described herein in relation to the electronic control unit 130. The first communication path 161a may communicatively couple the various components of the first smart elbow 150a, including the first tank tag reader 152a, the first hose tag reader 153a, the first processor 154a, the first memory module 155a, first network interface hardware 156a, the first lock sensor 157a, the first orientation sensor 158a, the first magnetic sensor 159a, and the first location sensor 160a.

Still referring to FIG. 3, the first processor 154a may be any device capable of executing machine readable instructions. Accordingly, the first processor 154a may be a controller, an integrated circuit, a microchip, a computer, or any other computing device. The first processor 154a may have any other feature or functionality of a processor previously described herein in relation to processor 132 of the electronic control unit 130. The first processor 154a may be communicatively coupled to the other components of the first smart elbow 150a by the first communication path 161a. While FIG. 3 shows one first processor 154a, in other embodiments, multiple processors may be communicatively coupled by the first communication path 161a, which may allow the multiple processors to operate in a distributed computing environment.

Still referring to FIG. 3, the first memory module 155a may be coupled to the first communication path 161a and communicatively coupled to the first processor 154a. The first memory module 155a may comprise RAM, ROM, flash memories, hard drives, or any device capable of storing machine readable instructions such that the machine readable instructions can be accessed and executed by the first processor 154a. The machine readable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable instructions and stored on the first memory module 155a. Alternatively, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. The first memory module 155a may have any other features or functionality of a memory module previously described herein in relation to the memory modules 134 of the electronic control unit 130.

Still referring to FIG. 3, first network interface hardware 156a may be coupled to the first communication path 161a and communicatively coupled to the first processor 154a. The network interface hardware may be any device capable of transmitting and/or receiving data via a network. Accordingly, the first network interface hardware 156a can include a communication transceiver for sending and/or receiving any wired or wireless communication. For example, the first network interface hardware 156a may include an antenna, a modem, LAN port, Wi-Fi card, WiMax card, mobile communications hardware, near-field communication hardware, satellite communication hardware and/or any wired or wireless hardware for communicating with other networks and/or devices, such as the crossover protection system 100, a location system 171 at the distribution station 178, the fleet management system 520, and/or the cloud system 530. In some embodiments, first network interface hardware 156a includes a wireless communication module configured to send and receive wireless communication with other devices, such as the crossover protection system 100. In some embodiments, first network interface hardware 156a communicates wirelessly according to the IrDA, Bluetooth, Wireless USB, Z-Wave, ZigBee, LoRa, LoRaWAN, Sigfox, MQTT and/or any other wireless communication protocols. The first network interface hardware 156a may have any other features or functionality of a memory module previously described herein in relation to the network interface hardware 136 of the electronic control unit 130.

Referring again to FIG. 3, the first tank tag reader 152a and the first hose tag reader 153a may be coupled to the first communication path 161a and communicatively coupled to the first processor 154a. The first tank tag reader 152a may be a tank tag reader configured to read a tank tag of a distribution tank when the first tank tag reader 152a is positioned sufficiently near the tank tag. Similarly, the first hose tag reader 153a may be a hose tag reader configured to read a tag of a delivery hose when the first hose tag reader 153a is positioned sufficiently near the hose tag. In some embodiments each of the first tank tag reader 152a and the first hose tag reader 153a may be RFID tag readers configured to read an RFID tag within the range of the reader. Alternatively, in other embodiments, the first tank tag reader 152a and/or the first hose tag reader 153a may be tag readers other than RFID tag readers, such as in embodiments in which the tank tag and/or the hose tag are tags other than RFID tags.

Still referring to FIG. 3, the first lock sensor 157a may be coupled to the first communication path 161a and communicatively coupled to the first processor 154a. The first lock sensor 157a may output a signal indicative of a position or configuration of the first locking lever 151a (FIG. 1) of the first smart elbow 150a, such as a signal indicative of the first locking lever 151a being in a locked configuration or in an unlocked configuration.

Still referring to FIG. 3, the first orientation sensor 158a may be coupled to the first communication path 161a and communicatively coupled to the first processor 154a. The first orientation sensor 158a may output a signal indicative of an orientation of the first smart elbow 150a (e.g., whether upright, horizontal, etc.) In some embodiments, the first orientation sensor 158a may be an inertial measurement unit, an accelerometer, or a gyroscope.

Still referring to FIG. 3, the first magnetic sensor 159a may be coupled to the first communication path 161a and communicatively coupled to the first processor 154a. The first magnetic sensor 159a may output a signal indicative of a strength of a magnetic field in which the first magnetic sensor 159a is positioned. In some embodiments, the first magnetic sensor 159a may be a hall effect sensor, though embodiments are not limited thereto.

Still referring to FIG. 3, the first location sensor 160a may be coupled to the first communication path 161a and communicatively coupled to the first processor 154a. The first location sensor 160a may output a signal indicative of a geographic location of the first location sensor 160 and, thus, the first smart elbow 150a, is positioned. In some embodiments, the first location sensor 160a may be a GNSS (Global Navigation Satellite System, satellite-based positioning, navigation, and timing systems) receiver or any other suitable transceiver to determine the smart elbow position.

Still referring to FIG. 3, the second smart elbow 150b may include a second tank tag reader 152b, a second hose tag reader 153b, a second processor 154b, a second memory module 155b, a second network interface hardware 156b, a second lock sensor 157b, a second orientation sensor 158b, a second magnetic sensor 159b, a second location sensor 160b, and a second communication path 161b. In some embodiments, the second tank tag reader 152b, the second hose tag reader 153b, the second processor 154b, the second memory module 155b, second network interface hardware 156b, the second lock sensor 157b, the second orientation sensor 158b, the second magnetic sensor 159b, the second location sensor 160b, and the second communication path 161b are the same as the first tank tag reader 152a, the first hose tag reader 153a, the first processor 154a, the first memory module 155a, first network interface hardware 156a, the first lock sensor 157a, the first orientation sensor 158a, the first magnetic sensor 159a, and the first communication path 161a of the first smart elbow 150a, respectively and are interconnected in the same way as the components of the first smart elbow 150a.

Although two smart elbows 150 are shown in the crossover protection system 100 of FIG. 3, it should be understood that there may be one, two, three, four, or more smart elbows within the crossover protection system. The description of FIG. 3 is not limiting and any number of components may be included in the crossover protection system 100.

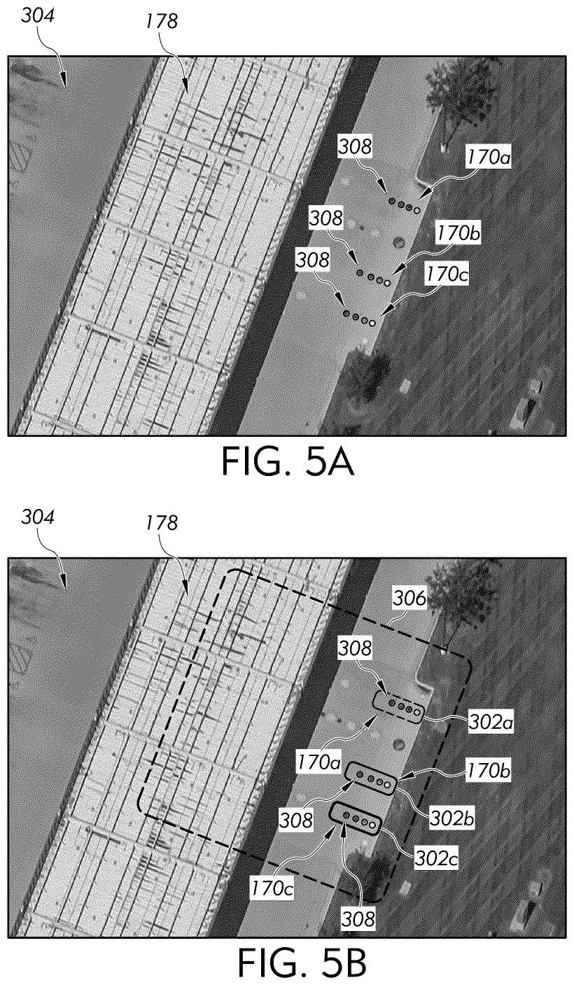

Referring now to FIG. 5A, a map 304 of the distribution station 178 is depicted. The distribution station 178 is depicted as having the first distribution tank 170a, the second distribution tank 170b, and a third distribution tank 170b. Although three distribution tanks 170 are depicted, it is contemplated that one, two, three, four, five, or more distribution tanks 170 may be located at any given distribution station 178. The distribution tanks 170 may correspond to a fuel type stored within the distribution tank 170. For example, the first distribution tank 170a may correspond to a regular unleaded fuel type, the second distribution tank 170b may correspond to a premium fuel type, and the third distribution tank 170c may correspond to a diesel fuel type. Each of the distribution tanks 170a, 170b, and 170b may include one, two, three, four, or more utility holes 308 that may connect to the inlets 172 or vapor outlets of the distribution tanks 170.

Referring now to FIG. 5B, geofences 302a, 302b, and 302c that correspond to the first distribution tank 170a, the second distribution tank 170b, and the third distribution tank 170c, respectively, are depicted. The geofences 302 correspond to each distribution tank 170 and, thus, correspond to a fuel type within the distribution tank 170. The geofences 302 may be oval (as depicted in FIG. 5B), circular, square, or any other suitable shape. The geofences 302 may be used to determine whether the location sensor 160 (i.e., the smart elbow position) is within the geofence 302 of the distribution tank 170 containing the same fuel type as the liquid product stored in the tank compartment 104 that the smart elbow 150 is fluidly coupled to (such as through the delivery hose 190). Also included may be a distribution station geofence 306. The distribution station geofence 306 may encompass each of the geofences 302 at the distribution station 178 that correspond to distribution tanks 170. In embodiments, the distribution station geofence 306 may be useful in that the processor 132 and/or electronic control unit 130 may only determine whether the smart elbow 150 is within a geofence 302 of the distribution tank 170 when the smart elbow is within the distribution station geofence 306. There may be a margin of error around the geofences 302 or distribution station geofence 306 of 0 feet, 1 foot, 2 feet, 3 feet, or more.

As described further below, the processor 132 and/or electronic control unit 130 may allow the flow of liquid product from the tank compartment 104 to the distribution tank 170 if the smart elbow 150 is within the geofence 302 of the distribution tank 170 with the same fuel type as the liquid product stored in the corresponding tank compartment 104, while the processor 132 and/or electronic control unit 130 may prevent the flow of the liquid product from the tank compartment 104 to the distribution tank 170 if the smart elbow 150 is outside (i.e., not within) the geofence 302 of the distribution tank 170 with the same fuel type as the liquid product stored in the corresponding tank compartment 104. Examples of such are further described herein.

The geofences 302 may be generated by a user. The user may draw on the map 304 of the distribution station 178 to generate the first geofence 302a, the second geofence 302b, the third geofence 302c, or any number of geofences, on a display of a distribution station device, the display 144 of the product delivery vehicle, or any other suitable display. Once the user draws the geofence 302, the user may choose to correspond the geofence to a fuel type, such that each of the geofences 302 correspond to a fuel type. In embodiments, the geofences 302 may be auto-generated through computer software that recognizes locations of the distribution tanks 170; the user may then choose the fuel type corresponding to each geofence 302, or the computer software may automatically correspond the fuel type that to each geofence 302.

The machine readable instructions stored on the memory module may cause the processor and/or the electronic control unit 130 to perform multiple functions as described herein. It should be understood that the machine readable instructions may cause either of the processor 132 or the electronic control unit 130 to perform the functions described herein, regardless of whether the processor 132 or the electronic control unit 130 is recited as performing such functions.

In embodiments, the machine readable instructions stored on the memory module 134 may cause the processor 132 to determine the smart elbow position based on the signal output of the sensors 160 (e. g, the location sensors 160a, 160b). The machine readable instructions may further cause the processor 132 to determine whether the smart elbow 150 is within the geofence 302 of a distribution tank 170 that contains the same fuel type as the liquid product stored in the tank compartment 104 of the product delivery vehicle 102.

In embodiments, the smart elbow position may also be determined through a position of the smart elbow 150 relative to a product delivery vehicle position. For example, the product delivery vehicle 102 may include a separate GNSS receiver independent of that of the GNSS receiver of the location sensor 160 to determine the product delivery vehicle position. The product delivery vehicle 102 may be communicatively coupled to the smart elbow 150 via Bluetooth, ultra-wideband, and/or similar technologies. As such, the electronic control unit 130 may determine a position of the smart elbow 150 by determining the relative position of the smart elbow 150 from the product delivery vehicle position. Determining the location of the smart elbow 150 relative to the product delivery vehicle 102 may help the user determine the smart elbow position when the location sensor 160 of the smart elbow 150 fails, or may be used in combination with the location sensor 160 of the smart elbow 150 for a more accurate determination of the smart elbow position.

In response to the determination that the smart elbow 150 is within the geofence 302 of the distribution tank 170 of the same fuel type as the liquid product in the tank compartment 104 that the smart elbow 150 is fluidly coupled to, the machine readable instructions may further cause the processor 132 to permit the liquid product to flow from the tank compartment 104 of the product delivery vehicle 102 to the distribution tank 170. In contrast, in in response to a determination that the smart elbow position 150 is outside the geofence 302 of the distribution tank 170 of the same fuel type as the liquid product in the tank compartment 104 that the smart elbow 150 is fluidly coupled to, the machine readable instructions may further cause the processor 132 to prevent the liquid product from flowing from the tank compartment 104 of the product delivery vehicle 102 to the distribution tank 170.

For example, if the smart elbow 150 is positioned within the first geofence 302a that corresponds to regular unleaded fuel in the first distribution tank 170a and the tank compartment 104 that the smart elbow 150 is fluidly coupled to is a liquid product of regular unleaded fuel, then the smart elbow 150 permits the flow of the regular unleaded fuel into the first distribution tank 170a that corresponds to the first geofence 302a through the delivery hose 190. However, if the smart elbow 150 is positioned within the third geofence 302c that corresponds to diesel fuel in the third distribution tank 170c and the tank compartment 104 that the smart elbow 150 is fluidly coupled to is a liquid product of regular unleaded fuel, then the smart elbow prevents flow of the regular unleaded fuel into the third distribution tank 170c that corresponds to the third geofence 302c.

The smart elbow 150 may permit or prevent the flow of liquid product from the tank compartment 104 to the distribution tank 170 through the unlocking or locking of valves. In embodiments, in response to the determination that the smart elbow position is within the geofence 302 of the distribution tank 170 of the same fuel type as the liquid product in the tank compartment 104 that the smart elbow 150 is fluidly coupled to, the machine readable instruction may cause the processor 132 to transition at least one valve (e.g., control valve 110 or internal valve 116) from a normally locked state to an unlocked state. In response to in response to the determination that the smart elbow position is outside the geofence 302 of the distribution tank 170 of the same fuel type as the liquid product in the tank compartment 104 that the smart elbow 150 is fluidly coupled to, the machine readable instruction may cause the processor 132 to maintain at least one valve (e.g., control valve 110 or internal valve 116) in the normally locked state. The at least one valve may be configured to fluidly couple to the smart elbow 150.

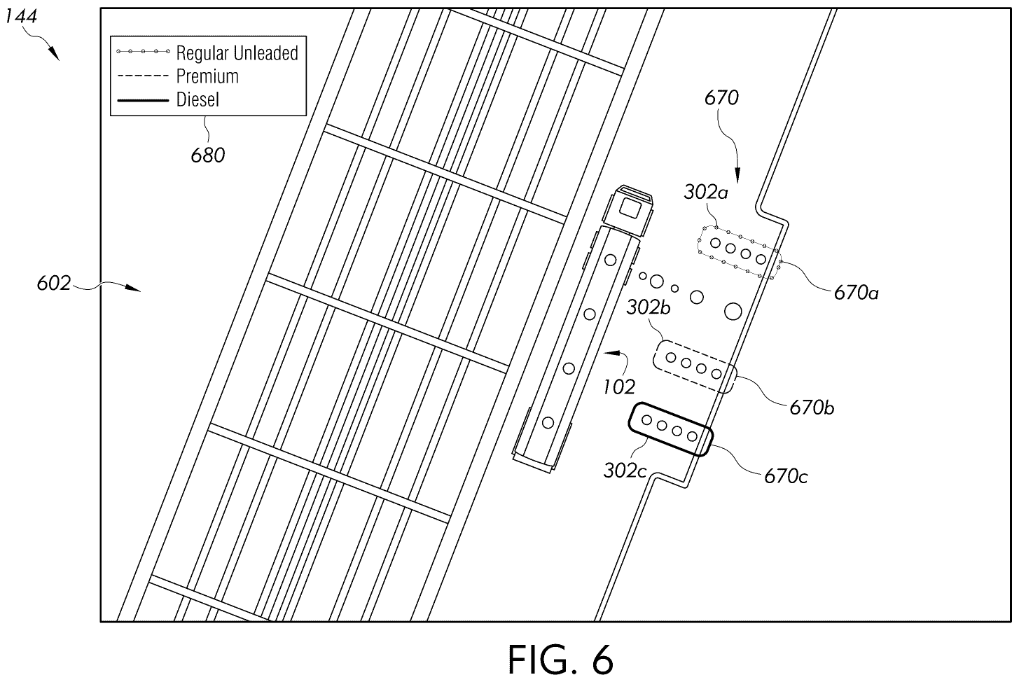

Referring now to FIG. 6, in embodiments, the machine readable instructions may further cause the processor 132 to display a graphical user interface 602 (such as a depiction of the map 304) on the display 144. The graphical user interface 602 may include a schematic representation of the product delivery vehicle 102 and the plurality of distribution tanks 170. The schematic representation may include a plurality of distribution tank graphics 670 and the plurality of distribution tank graphics 670 may include the geofence 302 for each of the plurality of distribution tanks 170.

In embodiments, the plurality of distribution tank graphics 670 may be color-coded, such that each of the geofences 302 corresponding to different distribution tanks 170 are of a different color. The plurality of distribution tank graphics 670 may also be pattern-coded, such that a different patterned line/graphic is used for each of the plurality of distribution tank graphics 670 so that different fuel types may be distinguished. For example, referring again to FIG. 6, a first distribution tank graphic 670a corresponding to the first distribution tank 170a that contains the regular unleaded fuel may be a dotted line pattern and/or white in color, a second distribution tank graphic 670b corresponding to the second distribution tank 170b that contains the premium fuel may be a dashed line pattern and/or red in color, and a third distribution tank graphic 670c corresponding to the third distribution tank 170c that contains the diesel fuel may be a solid line and/or yellow in color. In embodiments, the schematic representation may also include a tank key 680, displaying which colors of the distribution tank graphics 670 correspond to certain fuel types. The schematic representation may assist the user/driver of the product delivery vehicle 102 in determining which distribution tank 170 to fluidly couple the smart elbow 150. The schematic representation may also depict the smart elbow 150 and update as the product delivery vehicle 102 and the smart elbow 150 move in real time. Moreover, the schematic representation may assist users in drawing/generating the geofences around the distribution tanks 170. The display 144 may be a display on an interior cabin of the product delivery vehicle 102 or a display on a tank or exterior portion of the product delivery vehicle 102.

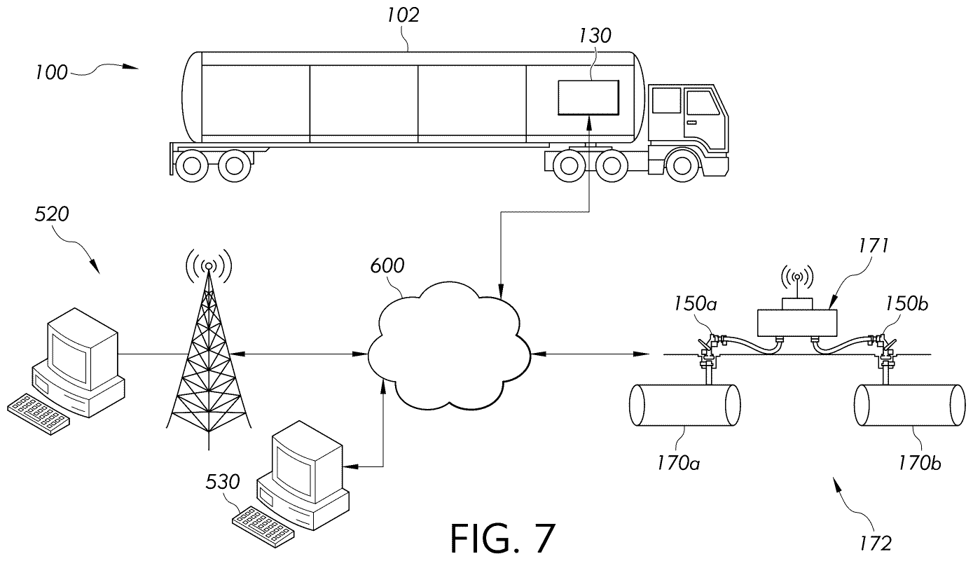

Referring now to FIG. 7, the cloud system 530 and/or the fleet management system 520 may be operable to obtain geographical location information for distribution stations 178 and define geofences 302 of the distribution tanks 170 based on the geographical location information obtained. In other embodiments, the geofences 302 may be defined at the distribution stations 178, such as drawn as an overlay on the map 304, or automatically generated through the computer software, as described herein. The geofences 302 defined at the distribution stations 178 may then be communicated to the cloud system 530 and/or the fleet management system 520 from the location system 171 at the distribution station 178, such as through the network 600. The machine readable instructions may further cause the electronic control unit 130 to establish a communication path (e.g., the network 600) between the network interface hardware 136 and the location system 171 at the distribution station 178, the fleet management system 520, and/or the cloud system 530 to receive the geofences 302 of the distribution tanks 170. The electronic control unit 130 may include computer readable and executable instructions that, when executed by the processor, may cause the electronic control unit 130 to receive the geofences 302 from the location system 171 at the distribution station 178, cloud system 530 and/or the fleet management system 520.

In embodiments, the geofences 302 at various distribution stations 178 may be stored in the one or more of the cloud system storage medium and accessed by the cloud system 530 for determining the geofence 302 corresponding to each of the distribution tanks 170. The geofences 302 may also be stored on the fleet management system 520. The geofences 302 may be communicated to the electronic control unit 130 through the communication path (e. g, the network 600). The geofences 302 may correspond to distribution tanks 170 at a plurality of distribution stations 178, such that the electronic control unit 130 may obtain geofences 302 for any distribution tanks 170 at a plurality of distribution stations 178 connected to the network 600. The geofences 302 may be updated daily, monthly, yearly, or any other suitable time-frame.

Also disclosed herein is a method for loading liquid product. The method may include determining the smart elbow position based on the signal output of the location sensor 160 of the smart elbow 150 and determining whether the smart elbow position is within the geofence 302 of the distribution tank 170 of the same fuel type as the liquid product. The method may further include permitting the liquid product to flow from the tank compartment 104 of the product delivery vehicle 102 to the distribution tank 170 in response to determining that the smart elbow position is within the geofence 302 of the distribution tank 170 of the same fuel type as the liquid product and preventing the liquid product from flowing from the tank compartment 104 of the product delivery vehicle 102 to the distribution tank 170 in response to a determination that the smart elbow position is outside (i.e., not within) the geofence 302 of the distribution tank 170 of the same fuel type as the liquid product.

The method may further include transitioning the at least one valve (e.g., the control valve 110 or internal valve 116) from a normally locked state to an unlocked state in response to the determination that the smart elbow position is within the geofence 302 of the distribution tank 170 of the same fuel type as the liquid product. The method may further include maintaining the at least one valve in the normally locked state in response to the determination that the smart elbow position is outside the geofence 302 of the distribution tank 170 of the same fuel type as the liquid product. Moreover, the method may also include displaying the graphical user interface 602 on the display 144. It is contemplated that any action executed by the electronic control unit 130 and/or the processor 132 may also be included as a method for loading liquid product. It is also contemplated that while the embodiments described herein are primarily directed to unloading liquid product at distribution stations, the systems and methods described herein may also be used for loading liquid product at loading stations using boundaries or geofences in combination with smart elbows and locations sensors to determine whether the correct type of fuel is being loaded into the product delivery vehicle.

The systems and methods described herein include benefits that prior systems do not include, such as the avoidance of cross-contamination of liquids at distribution stations utilizing location-based sensors and geofences. Valves of a product delivery vehicle may open once a smart elbow of the system has entered the geofence of a distribution tank of the same fuel type that the smart elbow is fluidly coupled to. A schematic representation of the system on a display allows for efficient and accurate use of the systems and methods described herein.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A crossover protection system comprising:
a processor of an electronic control unit;
a network interface hardware communicatively coupled to the processor;
at least one memory module communicatively coupled to the processor; and
machine readable instructions stored in the at least one memory module, wherein:
the machine readable instructions stored in the at least one memory module cause the processor to perform at least the following:
determine a smart elbow position based on a signal output of a sensor of a smart elbow, wherein the smart elbow is configured to be fluidly coupled to a tank compartment of a product delivery vehicle;
determine whether the smart elbow position is within a boundary or geofence of a distribution tank comprising a same fuel type as a liquid product, wherein the liquid product is stored in the tank compartment of the product delivery vehicle;
in response to a determination that the smart elbow position is within the boundary or geofence of the distribution tank of the same fuel type as the liquid product, permit the liquid product to flow from the tank compartment of the product delivery vehicle to the distribution tank; and
in response to a determination that the smart elbow position is outside the boundary or geofence of the distribution tank of the same fuel type as the liquid product, prevent the liquid product from flowing from the tank compartment of the product delivery vehicle to the distribution tank.

2. The crossover protection system of claim 1, wherein the machine readable instructions cause the processor to perform the following:
establish a communication path between the network interface hardware and a location system at a distribution station, a fleet management system, a cloud system, or combinations thereof; and
receive the boundary or geofence of the distribution tank from the location system, fleet management system, cloud system, or combinations thereof, wherein the boundary or geofence corresponds to the fuel type of the distribution tank within the boundary or geofence.

3. The crossover protection system of claim 2, wherein the boundary or geofence corresponds to the fuel type of a plurality of distribution tanks at a plurality of distribution stations.

4. The crossover protection system of claim 1, wherein the machine readable instructions cause the processor to perform the following:
in response to the determination that the smart elbow position is within the boundary or geofence of the distribution tank of the same fuel type as the liquid product, transition at least one valve from a normally locked state to an unlocked state, wherein the at least one valve is configured to fluidly couple to the smart elbow; and
in response to the determination that the smart elbow position is outside the boundary or geofence of the distribution tank of the same fuel type as the liquid product, maintain the at least one valve in the normally locked state.

5. The crossover protection system of claim 1, wherein the machine readable instructions cause the processor to perform the following:
display a graphical user interface on a display, the graphical user interface comprising:
a schematic representation of the product delivery vehicle and a plurality of distribution tanks, the schematic representation including a plurality of distribution tank graphics, the plurality of distribution tank graphics comprising the boundary or geofence for each of the plurality of distribution tanks.

6. The crossover protection system of claim 5, wherein the plurality of distribution tank graphics are color-coded.

7. The crossover protection system of claim 1, wherein the smart elbow position is determined through a GNSS (Global Navigation Satellite System, satellite-based positioning, navigation, and timing systems) receiver, or any other suitable transceiver communicatively coupled to the network interface hardware.

8. The crossover protection system of claim 1, wherein the smart elbow position is determined through a position of the smart elbow relative to a product delivery vehicle position.

9. A crossover protection system comprising:
a product delivery vehicle comprising a tank compartment for containing a liquid product;
an electronic control unit comprising a processor, a network interface hardware communicatively coupled to the processor, at least one memory module communicatively coupled to the processor, and machine readable instructions stored in the at least one memory module; and
a smart elbow fluidly coupled to the tank compartment and the smart elbow communicatively coupled to the electronic control unit, wherein:
the machine readable instructions stored in the at least one memory module cause the electronic control unit to perform at least the following when executed by the processor:
determine a smart elbow position;
determine whether the smart elbow position is within a boundary or geofence of a distribution tank comprising a same fuel type as the liquid product;
in response to a determination that the smart elbow position is within the boundary or geofence of the distribution tank of a same fuel type as the liquid product, permit the liquid product to flow from the tank compartment of the product delivery vehicle to the distribution tank; and
in response to a determination that the smart elbow position is outside the boundary or geofence of the distribution tank of the same fuel type as the liquid product, prevent the liquid product from flowing from the tank compartment of the product delivery vehicle to the distribution tank.

10. The crossover protection system of claim 9, wherein the smart elbow is communicatively coupled to the electronic control unit through Bluetooth, ultra-wideband, or both.

11. The crossover protection system of claim 10, wherein the smart elbow position is determined through a position of the smart elbow relative to a product delivery vehicle position.

12. The crossover protection system of claim 9, wherein the machine readable instructions cause the electronic control unit to perform the following when executed by the processor:
establish a communication path between the network interface hardware and a location system at a distribution station, a fleet management system, a cloud system, or combinations thereof; and
receive the boundary or geofence of the distribution tank from the location system at the distribution station, the fleet management system, the cloud system, or
combinations thereof, wherein the boundary or geofence corresponds to a fuel type of the distribution tank within the boundary or geofence.

13. The crossover protection system of claim 9, further comprising at least one valve coupled to the smart elbow and communicatively coupled to the electronic control unit, wherein the machine readable instructions cause the electronic control unit to perform the following when executed by the processor:
in response to the determination that the smart elbow position is within the boundary or geofence of the distribution tank of the same fuel type as the liquid product, transition the at least one valve from a normally locked state to an unlocked state; and
in response to the determination that the smart elbow position is outside the boundary or geofence of the distribution tank of the same fuel type as the liquid product, maintain the at least one valve in the normally locked state.

14. The crossover protection system of claim 9, wherein a distribution station comprises a plurality of boundaries or geofences of a plurality of distribution tanks, each of the plurality of boundaries or geofences corresponding to the fuel type.

15. The crossover protection system of claim 9, further comprising a display communicatively coupled to the electronic control unit, wherein the machine readable instructions cause the electronic control unit to perform the following when executed by the processor:
display a graphical user interface on the display, the graphical user interface comprising:
a schematic representation of the product delivery vehicle and a plurality of distribution tanks, the schematic representation including a plurality of distribution tank graphics, the plurality of distribution tank graphics comprising the boundary or geofence for each of the plurality of distribution tanks.

16. The crossover protection system of claim 15, wherein the plurality of distribution tank graphics are color-coded.

17. A method for loading liquid product, the method comprising:
determining a smart elbow position based on a signal output of a sensor of a smart elbow, wherein the smart elbow is configured to be fluidly coupled to a tank compartment of a product delivery vehicle;
determining whether the smart elbow position is within a boundary or geofence of a distribution tank comprising a same fuel type as a liquid product, wherein the liquid product is stored in the tank compartment of the product delivery vehicle;
permitting the liquid product to flow from the tank compartment of the product delivery vehicle to the distribution tank in response to determining that the smart elbow position is within the boundary or geofence of the distribution tank of the same fuel type as the liquid product; and
preventing the liquid product from flowing from the tank compartment of the product delivery vehicle to the distribution tank in response to a determination that the smart elbow position is outside the boundary or geofence of the distribution tank of the same fuel type as the liquid product.

18. The method of claim 17, further comprising:
establishing a communication path between a network interface hardware and a location system at a distribution station, a fleet management system, a cloud system, or combinations thereof; and
receiving the boundary or geofence of the distribution tank from the location system at the distribution station, the fleet management system, the cloud system, or
combinations thereof, wherein the boundary or geofence corresponds to the fuel type of the distribution tank within the boundary or geofence.

19. The method of claim 17, further comprising:
transitioning at least one valve from a normally locked state to an unlocked state, wherein the at least one valve is configured to fluidly couple to the smart elbow in response to the determination that the smart elbow position is within the boundary or geofence of the distribution tank of the same fuel type as the liquid product; and
maintaining the at least one valve in the normally locked state in response to the determination that the smart elbow position is outside the boundary or geofence of the distribution tank of the same fuel type as the liquid product.

20. The method of claim 17, further comprising displaying a graphical user interface on a display, the graphical user interface comprising a schematic representation of the product delivery vehicle and a plurality of distribution tanks, the schematic representation including a plurality of distribution tank graphics, the plurality of distribution tank graphics comprising the boundary or geofence for each of the plurality of distribution tanks.
